(19) United States
(12) Patent Application Publication
(10) Pub. No.: US 2026/0006709 A1
(43) Pub. Date: Jan. 1, 2026

(54) ELECTRODES WITH HIGH ASPECT RATIO FOR PLASMA GENERATION

(71) Applicant: Champion Aerospace LLC, Liberty, SC (US)

(72) Inventor: Artur P. Suckewer, Franklin Park, NJ (US)

(21) Appl. No.: 19/257,453

(22) Filed: Jul. 1, 2025

Related U.S. Application Data
(60) Provisional application No. 63/666,652, filed on Jul. 1, 2024.

(51) Int. Cl. H05H 1/24

(52) U.S. Cl. CPC H05H 1/24

(57) ABSTRACT

A plasma generating system having an igniter or other plasma generator for use in low pressure environments, such as occurs in aviation. Combustion is initiated with an electrode configuration having a large usable area of electrodes for high current plasma discharge over a longer length of the electrodes, resulting in a long useful life of the plasma generator. The plasma generation system includes circuitry that generates and propagate plasma along the electrodes by a Lorentz force and a thermal force using high currents that move the plasma along the electrodes without causing a destructive material state change in the electrodes.

### TECHNICAL FIELD

The present disclosure relates generally to plasma generation as may be implemented in an ignition system, such as for use in a low pressure environment (e.g., for at least some aerospace applications), but not limited thereto. More particularly, the present disclosure relates to improved electrode configurations for use in plasma generation that provide high performance and long useful life, especially for ignition in a low-pressure environment.

### BACKGROUND

Traveling spark igniters have been proposed for use in internal combustion engines with a focus on plasma formation and growth in a high-pressure and/or dense environment. Traveling spark igniters generate a plasma kernel by applying a high enough voltage between electrodes of the igniter to cause breakdown between the electrodes, at which point plasma is formed at the location of breakdown, and then the plasma kernel is propagated along the electrodes. The propagation is caused by Lorentz and thermal forces due to discharge current flowing between the electrodes through the plasma as it interacts with current flowing in the electrodes. Plasma propagation is desirable in some applications because movement of the plasma, while formed, increases the volume (e.g., swept and/or integrated over the propagation) in which ignition occurs as compared to a static plasma that remains entirely in one place before it recombines, transferring its energy substantially back into the solid structures from which it discharged.

More recently, such traveling spark igniters have been refined for use in especially high pressure (e.g., advanced automobile engine) environments. U.S. Pat. No. 7,467,612 B2, commonly owned with the assignee hereof, is an example of such an igniter. In a high-pressure environment, following breakdown and prior to total recombination of the plasma, one or more follow-on pulses of current are applied to the electrodes to generate corresponding pulses of Lorentz force to propagate and thermal force to expand the formed plasma along the electrodes.

### SUMMARY

In accordance with an aspect of the invention there is provided a plasma generation system, comprising a plasma generator that includes a first electrode, a second electrode; and an isolator spacing apart the first electrode and the second electrode. The plasma generation system further comprises circuitry configured to:
apply, across the first and second electrodes, a breakdown voltage sufficient to induce breakdown between the first and second electrodes, resulting in formation of plasma in an initiation region between the electrodes; and
apply, across the first and second electrodes, at least one subsequent pulse of electrical energy sufficient to propagate the plasma from the initiation region toward a distal tip of the first and second electrodes,
wherein a ratio of a length of the first and second electrodes, from the initiation region to the distal tip, to an edge-to-edge distance between the first and second electrodes, along the length of the first and second electrodes from the initiation region to the distal tip, is at least 1.75:1.

According to different embodiments, the plasma generation system may include any one of the following features, or any technically feasible combination of two or more of the following features.
the edge-to-edge distance is selected from a group consisting of:
a shortest edge-to-edge distance between the first and second electrodes along the length of the first and second electrodes from the initiation region to the distal tip;
a longest edge-to-edge distance between the first and second electrodes along the length of the first and second electrodes from the initiation region to the distal tip; and
an average edge-to-edge distance between the first and second electrodes along the length of the first and second electrodes from the initiation region to the distal tip.
each of the first and second electrodes extend from a surface of the isolator to the electrode's distal tip, and the initiation region is between the surface of the isolator and the distal tips, each of the first and second electrodes have a portion extending substantially parallel to the portion of the other electrode in a first direction, and the first electrode has a central axis extending in the first direction and the edge-to-edge distance is measured in a plane orthogonal to the central axis.
the first and second electrodes have an impedance between them and wherein, prior to breakdown, the impedance is lowest in the initiation region.
the isolator comprises ceramic and the initiation region is located at a surface of the ceramic.
the circuitry comprises:
a. an inductance through which the breakdown voltage is applied to the first and second electrodes; and
b. an energy storage device configured to apply the at least one subsequent pulse of electrical energy across the first and second electrodes via the inductance.
the inductance comprises a secondary of a transformer having a saturable core and a primary energized by the circuitry to create the breakdown voltage at the secondary, the energy storage device is configured to apply the at least one subsequent pulse of electrical energy across the first and second electrodes directly via the secondary, and the transformer is configured to maintain saturation of the saturable core between application of the breakdown voltage and application of the at least one subsequent pulse of electrical energy.
the circuitry further comprises:
a. a switching element coupled in a path from the first and second electrodes that includes the energy storage device and the inductance; and
b. a controller configured to close the switching element to pass the at least one subsequent pulse of electrical energy from the energy storage device to the inductance for applying across the first and second electrodes.
the circuitry is configured to apply the breakdown voltage and the at least one subsequent pulse of electrical energy only while the first and second electrodes are in an environment having a peak pressure below 300 pounds per square inch (PSI).

In accordance with a second aspect of the invention there is provided a plasma generation system, comprising a plasma generator that includes a first electrode, a second electrode, and an isolator spacing apart the first electrode and the second electrode. The plasma generation system further comprises circuitry configured to:
apply, across the first and second electrodes, a breakdown voltage sufficient to cause breakdown between a first point on the first electrode and a second point on the second electrode, resulting in formation of plasma in an initiation region between the first point and second point; and
apply, across the first and second electrodes, subsequent pulses of electrical energy sufficient to propagate the plasma from the first point to a distal tip of the first electrode,
wherein the first electrode has a propagation length extending in a first direction from the first point to the distal tip of the first electrode;
wherein the first and second electrodes have an edge-to-edge distance between the electrodes measured along the propagation length in one or more planes orthogonal to the first direction; and
wherein the ratio of the propagation length of the first electrode to the edge-to-edge distance is at least 1.75:1.

According to different embodiments, the plasma generation system of this second aspect of the invention may include any one of the following features, or any technically feasible combination of two or more of the following features.
the ratio is not more than 12:1.
the circuitry is configured to apply the subsequent pulses at a current in excess of 450 Amps.
the circuitry is configured to apply one or more of the subsequent pulses at a current in excess of 600 Amps.
the circuitry is configured to apply one or more of the subsequent pulses with a current rise time rate of at least 20 usec/100 Amps.
the plasma generation system further comprises one or more additional electrodes spaced from the first electrode by the insulator, the additional electrode(s) being electrically connected to the second electrode whereby the circuitry applies the breakdown voltage and subsequent pulses between the first electrode and both the second electrode and additional electrode(s), wherein the additional electrode(s) have an edge-to-edge distance with the first electrode such that the ratio of the propagation length of the first electrode to the edge-to-edge distance of the additional electrode(s) is at least 1.75:1.
the circuitry is configured to control one or more of the following parameters of the subsequent pulses: pulse timing, pulse energy, pulse width, pulse amplitude, current rise time, current rise time rate, voltage rise time, and voltage rise time rate.

In accordance with another aspect of the invention there is provided an ignition system for combusting fuel in a reaction environment, wherein the ignition system comprises any of the plasma generation systems above, and wherein the plasma generator comprises an igniter of the ignition system.

In accordance with yet another aspect of the invention there is provided an ignition system comprising an igniter that includes a first electrode having a distal tip, a second electrode, and an isolator spacing apart the first electrode and the second electrode, the first electrode having an exposed length extending from the isolator to the distal tip. The ignition system further comprises circuitry configured to:
apply, across the first electrode and the second electrode, a breakdown voltage sufficient to cause breakdown between the first electrode and the second electrode at a point along the exposed length of the first electrode, resulting in formation of plasma between the first and second electrodes; and
apply, across the first electrode and the second electrode, one or more subsequent pulses of electrical energy sufficient to maintain the plasma during and between application of the pulses,
wherein a ratio of the exposed length of the first electrode to an edge-to-edge distance between the first electrode and the second electrode is at least 1.75:1.

In one embodiment of this ignition system the second electrode has a distal tip and an exposed length extending from the isolator to the distal tip of the second electrode, wherein:
the exposed length of the first electrode is less than the exposed length of the second electrode;
the exposed length of the first electrode is equal to the exposed length of the second electrode; or
the exposed length of the first electrode is greater than the exposed length of the second electrode.

In another embodiment of this ignition system when the exposed length of the first electrode is less than the exposed length of the second electrode, then the ratio is a ratio of the exposed length of the first electrode to the edge-to-edge distance along the exposed length of the first electrode and, when the exposed length of the first electrode is greater than the exposed length of the second electrode, then the ratio is a ratio of the exposed length of the first electrode to the edge-to-edge distance along the exposed length of the second electrode.

In accordance with another aspect of the invention there is provided a plasma generator, comprising a housing, a first electrode, a second electrode, and an isolator mounted in the housing, the first and second electrodes being spaced apart by the isolator. Each of the first and second electrodes are mounted in the housing and extend from the housing to a distal tip. The first and second electrodes each include an electrode surface extending from the isolator to the distal tip of the electrode. The electrode surfaces of each electrode include a firing region extending for a length L along the electrodes. The firing regions each comprise a portion of the electrode surface that is located nearer to the other electrode's surface than any other portion of the electrode surface. The electrodes have an edge-to-edge distance D along the length L of the firing region, and the ratio of the length L to the edge-to-edge distance D along the length is at least 1.75:1.

According to different embodiments, the plasma generator of the immediately preceding paragraph may include any one of the following features, or any technically feasible combination of two or more of the following features.
the isolator has an exposed isolator surface located between the first and second electrodes at a proximal end of the electrodes, wherein the first and second electrodes have an impedance between them and wherein, prior to breakdown, the impedance is lowest on the isolator surface.
the firing region extends from the isolator surface to the distal tip of each of the electrodes, whereby the length L is the distance from the isolator surface to the distal tip of at least one of the electrodes.
the first and second electrodes extend above the isolator surface by different distances such that one of the electrodes is a longer electrode and the other of the electrodes is a shorter electrode, and wherein the length is the distance from the isolator surface to the distal tip of the shorter electrode.
the plasma generator further comprises an inductance coupled to the first and second electrodes, the inductance comprising a coil having no more than 100 turns.

In accordance with yet another aspect of the invention there is provided an ignition system comprising any of the plasma generators above along with and circuitry configured to:
apply, across the first and second electrodes, a breakdown voltage sufficient to cause breakdown between the first and second electrodes, resulting in formation of plasma in the firing region between the electrodes; and
apply, across the first and second electrodes, at least one subsequent pulse of electrical energy sufficient to propagate the plasma along the firing region toward the distal tips of the first and second electrodes.

The foregoing summary is provided by way of example and is not intended to be limiting. Moreover, aspects of the present disclosure may be implemented individually or in any combination depending on the application.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing.

FIG. 1 illustrates an example plasma generation system including a cross-section of a plasma generator and circuitry configured to apply electrical energy across electrodes of the plasma generator, according to some embodiments.

FIG. 2A illustrates a top view of an example plasma generator having an isolator spacing apart a plurality of electrodes that may be included in the plasma generation system of FIG. 1, according to some embodiments.

FIG. 2B illustrates a side view of a cross-section of the plasma generator of FIG. 2A, according to some embodiments.

FIG. 2C illustrates a side view of a cross-section of an alternative example plasma generator that may be included in the plasma generation system of FIG. 1, according to some embodiments.

FIG. 3 illustrates example plasma generation circuitry that may be included in the plasma generation system of FIG. 1, according to some embodiments.

FIG. 4 illustrates an example application of pulses of electrical energy following breakdown in the plasma generation system of FIG. 1, according to some embodiments.

FIG. 5A illustrates another example application of follow-on current following breakdown in the plasma generation system of FIG. 1, according to some embodiments.

FIG. 5B illustrates an alternative example application of follow-on current following breakdown in the plasma generation system of FIG. 1, according to some embodiments.

FIG. 6 illustrates a side view of an example igniter that may be included as at least a portion of a plasma generator in the plasma generation system of FIG. 1, according to some embodiments.

FIG. 7 shows a top view of the igniter of FIG. 6 showing an inner electrode and a plurality of outer electrodes.

FIG. 8 depicts an alternative firing end of the igniter of FIG. 6 having outer electrodes that are shorter than the inner electrode.

### DETAILED DESCRIPTION

The present disclosure provides plasma generation configurations that may be implemented to enlarge the usable area of electrodes for plasma discharge over a longer length in a plasma generator (e.g., igniter), resulting in a long useful life of the electrodes. In some embodiments, electrode configurations described herein may be implemented to improve longevity of a traveling spark igniter that is configured to generate and propagate plasma using a Lorentz force and a thermal force.

The present disclosure provides plasma generation techniques that may be implemented to maintain plasma coherence, resulting in high performance and long useful life of components, and which are suitable for use in a low pressure environment (e.g., as in some aerospace applications) but are not limited thereto. In some embodiments, plasma generation and coherence maintaining techniques may be implemented to improve construction and/or operation of a traveling spark igniter that is configured to generate and propagate plasma using a Lorentz force and thermal force.

As used herein, a “low-pressure environment” is an environment in which the pressure at the electrodes of a plasma generator (e.g., igniter) is 300 psi or below. By contrast, a “high-pressure environment” is an environment in which the pressure at the electrodes of a plasma generator (e.g., igniter) is above 300 psi.

Some aspects of the present disclosure leverage a recognition that plasma generation and propagation techniques developed for high-pressure environments may provide substandard or even inoperable performance in some relatively lower pressure environments. For example, in a high-pressure environment, the density of the environment is highly resistive to generation, growth, and movement of plasma, which may necessitate a high breakdown voltage and the use of techniques dedicated to increasing growth and extending movement of the plasma. In contrast, in a low-pressure environment, where plasma meets significantly less resistance to generation, growth, and movement, such techniques would result in a substantially uncontrolled explosion of energy and/or undesirably high thermal wear on (e.g., expansion of) components of the system. If plasma coherence is not maintained in at least some respects, the plasma may break apart and thus not grow and move as may be desired (e.g., for a traveling spark igniter). Moreover, while a large amount of electrical energy provided to a plasma generator may translate into a large Lorentz force, it may also, if not carefully controlled, lead to extensive wear on the plasma generator (e.g., electrodes).

To overcome the inapplicability of some high-pressure plasma generation techniques to other environments, the inventors have developed new plasma generation techniques that, in some aspects, achieve a balance of plasma propagation with thermal expansion of components of the system, which provide high performance and long useful life of the system components. For example, plasma generation techniques described herein may, in some aspects, maintain and propagate plasma while spreading the energy discharge used for plasma generation and propagation over a larger component area over time and limiting the amount of energy discharge at any given point over that component area. In this or in similar manner, components such as electrodes may wear slowly to achieve a long usable life without sacrificing high performance.

Some aspects of the present disclosure relate to applying, after breakdown, an amount of electrical energy sufficient to directionally propagate the plasma while keeping thermal expansion of the electrodes below a threshold thermal expansion amount (e.g., based on a pressure gradient in which the electrodes are disposed). It is recognized that thermal expansion of components of the system should be taken into consideration in addition to the desired directional propagation of the plasma, such as by limiting the amount of electrical energy applied to the components (e.g., at any given point along an electrode).

Some aspects of the present disclosure relate to applying subsequent pulses of follow-on current that are controlled pulses; for example, having a pulse duration that is short enough to prevent or inhibit material state alteration of components of the system (e.g., at points along the electrodes where current discharge via the plasma occurs). It is recognized that follow-on current pulse duration may be controlled to balance Lorentz force (e.g., for plasma propagation) with wear to components of the system, such as by applying follow-on current at a high enough amplitude and/or for a long enough time to achieve a desired Lorentz force but a short enough time that the locations of along the electrodes from which current is discharged into the plasma do not undergo an alteration of their material state, such as from solid to non-solid (e.g., liquid or vapor, through melting, vaporization, and/or sublimation). For instance, points along the electrodes at which plasma initiates may not undergo alteration of their material state at least until after plasma has propagated to distal tips of the electrodes, and/or at least until after the distal tips have undergone at least some material state alteration.

Apart from pulse duration (pulse width), the plasma generation circuit can be configured to control one or more other parameters of the subsequent pulses: pulse timing, pulse energy, pulse amplitude, current rise time, current rise time rate, voltage rise time, and voltage rise time rate. Techniques and circuitry to control these other parameters of the subsequent pulses will be know to those skilled in the art.

Some aspects of the present disclosure relate to applying one or more pulses of follow-on current having a high (e.g., 300 A, 450 A, or higher) peak current at a time at which the ordinarily expected current following breakdown (e.g., without applying the follow-on current) would otherwise be lower (e.g., lower than the high peak current at that time). It is recognized that, in a high-pressure environment, high current pulses of follow-on current may be unnecessary and cause undue wear to components of the system. But, outside of high-pressure environments, a high peak current pulse of follow-on current may be controlled to produce a high Lorentz force (e.g., for plasma propagation) while causing relatively low wear to components of the system. It is further appreciated that an even higher peak current (e.g., 550 A, 600 A, 1200 A, up to at least 1500 A with suitable electrical power supply components) may be appropriate for some circumstances, such as where shorter rise and/or fall times are achievable and/or where pressure and/or temperature conditions will permit higher current without causing a significant increase in wear.

Some aspects of the present disclosure relate to applying one or more pulses of follow-on current including a pulse having a fast current rise time (e.g., shorter than 20 μs, 15 μs, 10 μs, or 5 μs depending on the embodiment) and/or a fall time that is as fast as is practically achievable. The rise time can relate to and/or be dependent upon the peak amplitude of current delivered by the pulse, such that higher currents delivered by the pulses may have a rise time that is no more than 100 μs for 600 A of current or, in other embodiments that is no more than 60 μs for 600 A. The current rise times of the pulses can be characterized based on a rise time rate rather than a total rise time; for example, as a number of microseconds per 100 A of current. In some embodiments, the circuitry is configured to supply current at a rise time rate of at least 17 μs per 100 A (17 μs/100 A). Various other embodiments may provide a current rise time rate of at least 10 μs/100 A, at least 13 μs/100 A, or at least 20 μs/100 A. These rise times can be achieved by suitable design and selection of power storage devices (e.g., capacitors), magnetics (e.g., transformer capacity), and switch devices (e.g., transistors) to supply the current levels desirable or needed for a particular application of the plasma generating system.

In this way, the follow-on current pulse rise and/or fall times may be controlled to achieve a high Lorentz force over a relatively short amount of time, thereby producing a relatively low amount of wear on locations along the electrodes where energy discharges into the plasma. For example, applying a same amount of energy (e.g., current integrated over time) to the electrodes over a shorter amount of time may achieve a substantially higher Lorentz force while causing less wear on the electrodes than if the same amount of energy were applied over a longer amount of time.

Some aspects of the present disclosure relate to applying a controlled discharge (e.g., a breakdown voltage and follow-on current achieving a high discharge current through formed plasma) that collectively comprises an amount of energy exceeding ⅓ J with the intent of the energy delivery being structured to higher Lorentz force to thermal force ratio for a given energy compared to high pressure environment applications (e.g., exceeding ½ J). It is recognized that, in high-pressure environments, applying so much as ⅓ J for plasma generation will not produce coherent plasma with propagation beyond 0.2 inches beyond the distal tips due to the resistance present from the dense environment into which current is discharged. In contrast, where high-pressure performance is not in particular focus, techniques described herein may facilitate applying significant amounts of energy (e.g., ⅓ J, 0.5 J, 2 J, 4 J, 10 J) to electrodes of a plasma generation system and maintaining plasma coherence while achieving significant plasma propagation by skewing the energy delivery toward high Lorentz force to thermal force ratio for a given energy input, the plasma will tend to stay together as it projects.

Some aspects of the present disclosure relate to applying follow-on current to electrodes that are only proximate, at least in part (e.g., their distal tips), to an environment having a pressure below 300 PSI, such as below 150 PSI. Other aspects the present disclosure relate to applying the breakdown voltage and/or subsequent (follow-on) pulses to the electrodes while they are in a low pressure environment. It is recognized that follow-on current may be beneficially and controllably applied to prevent total recombination of and/or directionally propagate plasma even in low-pressure environments, such as by (but not limited to) leveraging one or more other aspects described above.

Previous efforts at implementing a traveling spark igniter focused on a high-pressure environment, significant projection of the plasma along the length of the electrodes may be impractical. For instance, in an advanced automotive engine, energy deposited into the plasma via electrode discharge is limited due to a relatively small amount of energy being used to produce a relatively small amount of plasma growth and propagation as is practically achievable and useful in that environment. As such, relatively short electrode lengths and a relatively low ratio of electrode length to electrode separation distance have been used.

Some aspects of the present disclosure leverage a recognition that it is beneficial, in low pressure environments, to run high currents (e.g., greater than 450 A, greater than 600 A, or more up to at least 1200 A) through electrodes having a high ratio of an electrode length to a separation distance (e.g., edge-to-edge) between electrodes along the electrode length. For example, where a short electrode length is used, plasma propagation may continue beyond the distal tip(s) of the electrodes, resulting in a stationary location of discharge at the distal tip(s) and thereby causing significant wear at the distal tip(s). For instance, the distal tip(s) may wear first over the course of each discharge cycle, resulting in shortening of the electrodes over time, and thereby further concentrating discharge over an even smaller area of the electrodes over the usable life of the plasma generators. This in turn may further accelerate wear on the plasma generator once wear has begun. At the same time, it is recognized that propagation (e.g., projection) of the plasma beyond the distal tip(s) of the electrodes may be desirable, and thus reducing wear by forcing an earlier termination of the plasma propagation along the electrodes may be undesirable.

To overcome these drawbacks of relatively short electrodes, it may be advantageous to have a relatively longer length of the electrodes than has been previously used. For example, the length of the electrodes as described herein may be, according to various embodiments, between where plasma initially forms between the electrodes and a distal tip of at least one of the electrodes, and/or a length along which plasma propagates and which terminates at a distal tip of at least one of the electrodes. It is recognized that a relatively large electrode length (e.g., in a region of plasma formation and/or propagation) may provide more area for plasma propagation between the electrodes, resulting in correspondingly less wear at the distal tip(s). At the same time, it may be advantageous to have a relatively close spacing between the electrodes along that length, so as to keep field strength high along the length of the electrodes and the breakdown voltage and/or the amount of energy needed to prevent total recombination of the plasma low, which in turn may also limit wear on the electrodes. Thus, an electrode configuration satisfying such a ratio as described herein may provide a long useful life in a plasma generation system such as a traveling spark igniter.

Moreover, in some embodiments, an upper limit of electrode length or length to separation distance ratio may be set on a case-by-case basis depending on an environment in which the electrodes are deployed. For example, where an electrode length would result in heat and/or thermal conduction at the distal tip(s) of the electrodes from other elements in the environment, resulting in too much wear at the distal tip(s) from the thermal conduction path being too long, the electrodes may be configured short of that length.

According to some aspects of the present disclosure, a plasma generation system may include a plasma generator having at least two electrodes spaced apart by an isolator, and the plasma generation system may further include circuitry configured to apply a breakdown voltage and at least one subsequent pulse of energy to the electrodes. For example, the breakdown voltage may be sufficient to induce breakdown between the electrodes, resulting in formation of plasma in an initiation region, and/or between a first point of a first electrode and a second point of a second electrode. In this or another example, the subsequent pulse(s) of energy may be sufficient to propagate plasma from the initiation region and/or the first point of the first electrode toward a distal tip of at least one of the electrodes (e.g., the first electrode). Alternatively or additionally, the subsequent pulse(s) of energy may be sufficient to prevent total recombination of previously formed plasma.

In some embodiments, a ratio of a length of the electrodes, such as of the first electrode, to an edge-to-edge distance between the electrodes along that length, may be at least a certain amount (e.g., 1.75:1 or greater, 2:1 or greater, 2.25:1 or greater, and/or 3:1 or greater and, in some embodiments, up to a maximum ratio, e.g., not more than 10:1). A length of the electrodes may be from an initiation region, at which plasma initially forms at breakdown, to a distal tip of at least one of the electrodes. In the same or another example, a length of the electrodes may be from a first point of a first electrode to a distal tip of the first electrode, where plasma is formed (e.g., initially) between the first point and a second point of a second electrode. In the same or yet another example, a length of the electrodes may be a propagation length along which plasma is propagated along the electrodes and terminating at a distal tip of at least one of the electrodes. In some embodiments, a desired ratio between length and distance may be determined using characteristics of the environment, such as the expected average (e.g., median) pressure of the environment.

In some embodiments, a length of the electrodes may be a length along which at least two electrodes are substantially parallel and extend above, or both above and below an initiation region (e.g., a surface of an isolator that spaces apart the electrodes), for example with the ratio being at least 3:1. For instance, a length may include substantially parallel regions outside of plasma propagation and/or initiation, while contributing to lengthening the usable area of the electrodes for discharge. In some embodiments, a length of a shortest of the electrodes may satisfy a ratio of at least 1.75:1. In some embodiments, a length of a longest of the electrodes may satisfy a ratio of at least 3:1.

According to various embodiments, the edge-to-edge distance is a separation distance between electrodes and may be and/or include a shortest edge-to-edge distance along the length, a longest edge-to-edge distance along the length, and/or an average edge-to-edge distance along the length. For example, the edge-to-edge distance may vary depending on the electrode configuration (e.g., tapering). The edge-to-edge distance may be measured in a plane orthogonal to a central axis of one or both of the electrodes

According to various embodiments, the electrode length may be at least 0.08 inches (2 mm), 0.12 inches (3 mm), and/or 0.16 inches (4 mm). For example, in an environment in which longer plasma propagation is desired and pressure is expected to be sufficiently low, a longer electrode length (e.g., than previously used) may be desirable.

It should be appreciated that, according to various embodiments, aspects of the present disclosure may be implemented individually or in suitable combination.

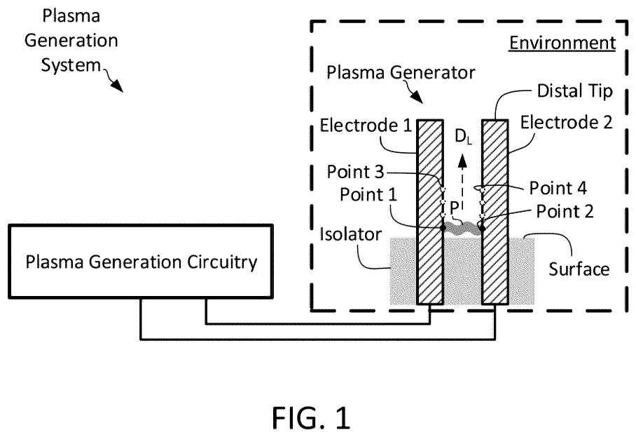

Turning to the figures, FIG. 1 illustrates an example plasma generation system including at least two electrodes and circuitry configured to apply electrical energy to the electrode(s), according to some embodiments.

As shown in FIG. 1, a plasma generator is disposed at least in part in an environment. For example, in FIG. 1, the plasma generator includes at least two electrodes (e.g., additional electrodes may be present though not shown). In some embodiments, the environment may be an ignition environment in which it is desired to form and/or propagate plasma to ignite an air-fuel mixture. In the illustrated embodiment, at least distal tips of the electrodes are proximate to the environment, though in other cases, more of the electrodes may be exposed to the environment. In some embodiments, the illustrated environment may be a low-pressure environment. For example, the plasma generation system may be configured for use in some aerospace applications, such as for ignition within certain aircraft engine environments, including for instance at flight altitude. In some embodiments, a plasma generation system may be configured to generate and maintain coherent plasma at pressures up to (e.g., only up to) 300 PSI, 175 PSI, or 150 PSI. In some embodiments, a plasma generation system may be configured for operation at a low-pressure value (e.g., 150 PSI) in that the plasma generation system is capable of controllably and coherently forming, maintaining, and propagating plasma at least up to that low-pressure value.

In some embodiments, a plasma generation system may be configured to apply across at least two electrodes, a breakdown voltage sufficient to induce breakdown between the electrode(s), resulting in formation of plasma between the electrode(s). For example, as shown in FIG. 1, a first electrode 1 and a second electrode 2 may receive the breakdown voltage thereacross, such as by having the breakdown voltage applied to one electrode and a reference voltage (e.g., ground) applied to the other electrode. For instance, the breakdown voltage may be sufficient that a dielectric (e.g., air gap) between the electrodes may breakdown and form plasma that provides a conductive path between the electrodes through which current may flow.

In some embodiments, breakdown between the electrode(s) may result in formation of plasma in an initiation region. For example, in FIG. 1, a plasma kernel P is shown formed between the electrodes 1 and 2 between a first point 1 and a second point 2. For instance, the first point 1 and the second point 2 may form the initiation region with initial plasma formation therebetween. In some embodiments, the initiation region may be a region at which electrical discharge between the electrodes begins, thereby providing a conductive path within that region through the plasma. For example, the initiation region may be where, prior to breakdown (and/or prior to formation of plasma and/or prior to system-induced ionization), impedance is lowest between the electrodes. In the illustrated embodiment, the electrodes 1 and 2 are separated by an isolator, which may include ceramic, such that a surface of the isolator provides a lowest impedance path between the electrodes 1 and 2. For instance, the initiation region may be at or proximate the surface of the isolator. In some embodiments, the surface of the isolator may be treated (e.g., with a conductive agent that induces semiconductive behavior) to further reduce the impedance proximate the surface, as this may reduce the breakdown voltage needed to initiate plasma. In some embodiments that are configured to propagate plasma along a length of the electrodes, an initiation region may be a first location from which the plasma is propagated (e.g., terminating at least at the distal tips of the electrodes).

It should be appreciated that the electrodes may not be separated along their entire lengths by any given isolator and/or alternative or additional material (e.g., including a gap) may be between the electrodes along at least a portion of their length, such as due to manufacturing tolerance.

It should be appreciated that multiple initiation regions may be present in a plasma generator as formed and/or configured for use. For example, where electrodes are manufactured with portions projecting towards one another, such portions may provide a lowest impedance path between the electrodes prior to at least some applications of the breakdown voltage. In the same example, portions projecting towards one another may be destroyed after several applications of the breakdown voltage such that other points along the electrodes have a lowest impedance path between the electrodes. Any or each of such points may be considered an initiation region in which the electrodes are configured to initially form plasma following application of a breakdown voltage, even before destruction of some portions that form an initiation region.

According to various embodiments, the electrode(s) may have any suitable configuration. For example, electrodes may be present in a coaxial configuration. In the same or another example, more than two electrodes may be present, such as with some of the electrodes configured as anodes (e.g., receiving the breakdown voltage) and some of the electrodes configured as cathodes (e.g., receiving a reference voltage, or vice versa). For instance, in a rail configuration, multiple electrodes may be spaced from one another and/or from another electrode (e.g., a central electrode), such as with one electrode configured as an inner electrode and other electrodes configured as outer electrodes.

According to one aspect of the present disclosure, a plasma generation system such as shown in FIG. 1 may be configured to apply to the electrode(s), after applying the breakdown voltage and before total recombination of the plasma, a follow-on current through the plasma. For example, following breakdown and without application of follow-on current, the plasma may naturally recombine as the amount of current flowing through the plasma decreases then stops. For instance, the follow-on current may flow through the plasma thereby sustaining the plasma and maintaining the conductive path therethrough. Moreover, as described further herein, the follow-on current may create a Lorentz force that propagates the plasma along the electrode(s).

In some embodiments, the follow-on current may have a peak current that exceeds 450 A at a time at least two microseconds following breakdown. For example, as described above, some aspects of the present disclosure leverage the recognition that applying a high peak current (e.g., for a short period of time and/or in a low-pressure environment) may produce a large Lorentz force (e.g., for propagating the plasma along the electrodes) while limiting wear on the electrodes (e.g., at any particular point along the electrodes). In some embodiments, a peak current exceeding 450 A may provide a sufficient balance of Lorentz force with wear on the electrodes and coherence of the resulting plasma, whereas in other cases, temperature and/or pressure conditions and/or material used in the electrodes may permit an even larger peak current, such as exceeding 550 A, exceeding 600 A, or higher, to achieve an even higher Lorentz force.

In some embodiments, after applying the breakdown voltage and before total recombination of the plasma, a pulse of current may be applied having a peak current greater than 450 A at a time at which current flowing between the electrode(s) would be lower than the peak current without application of the pulse of current. For example, at least two microseconds following breakdown and without the follow-on current, the current level through the plasma from applying the breakdown voltage may be rapidly falling. As such, without applying the follow-on current, less than 450 A, such as a much smaller amount of current on the order of a few A, might otherwise be flowing through the plasma at the time the follow-on current has the peak current level. In another example, the follow-on current may be applied while the current is falling following breakdown is or exceeds 450 A. For instance, the follow-on current may supply a further 450 A beyond the level of current flowing through the plasma at the time the follow-on current has the peak current level.

In some embodiments, applying the pulse of current may include propagating the plasma along a length of the electrode(s). For example, in a traveling spark igniter configuration, current flowing through the electrodes 1 and 2 may cause a Lorentz force to push the plasma along the length of the electrodes 1 and 2 (e.g., along the length direction D_{L}). For instance, following application of a pulse of current, the plasma kernel P shown in FIG. 1 may move in the length direction D_{L} towards distal tips of the electrodes 1 and 2. In some embodiments, applying a sequence of multiple pulses of follow-on current prior to total recombination of the plasma may sustain propagation of the plasma kernel P with each pulse beyond any initial propagation that may be induced by application of the breakdown voltage.

According to another aspect of the present disclosure, a plasma generation system such as shown in FIG. 1 may be configured to, apply, to the electrode(s), after applying the breakdown voltage and before total recombination of the plasma, a follow-on current having a pulse duration that is short enough to prevent material state alteration of at least a portion of the electrode(s). For example, material state alteration may include a material state change from a first material state (e.g., solid) to a second material state (e.g., non-solid). For instance, upon application of a significant amount of electrical energy to an electrode (e.g., as may occur during breakdown and/or application of follow-on current), material of the electrode (e.g., where electrical discharge into the plasma occurs) may heat to the point of liquification, by melting into liquid, vaporization, by transitioning from solid to liquid to vapor, and/or sublimation by transitioning directly from solid to vapor. In contrast, however, according to some aspects described herein, a pulse duration may be used such that material of the electrode does not heat so much as undergo material state alteration. For instance, application of electrical energy to any given point along the electrode(s) (e.g., as the plasma kernel P propagates in the length direction D_{L}) may be made short enough to spread heat and resulting wear over the electrode(s) to prevent (e.g., at least prolong) material state alteration, thereby improving the longevity of the electrode(s).

In some embodiments, the pulse duration may be short enough to prevent material of the electrode(s) at the first point and at the second point from changing from a first material state to a second material state, such as from solid to non-solid (e.g., liquid or vapor). For example, the follow-on current may flow between the first point 1 and the second point 2 in FIG. 1, which may be where plasma initiates, and/or the follow-on current may flow through another pair of points (e.g., spaced along the electrodes in the length direction D_{L}), such as where plasma propagates at least some distance between breakdown and application of the follow-on current. In some embodiments, the pulse duration may be short enough to prevent material alteration of the electrode(s) at the first point 1 and at the second point 2. In the illustrated embodiment, the first point 1 and the second point 2 are prior to distal tips of the electrodes along a length of the electrode(s) shown in a length direction D_{L} in FIG. 1.

In other embodiments, the first point 1 and the second point 2 may be at least prior to the distal tip of one of the electrodes, such as where the electrodes have different lengths (e.g., resulting in their distal tips being offset in the length direction D_{L}). In some embodiments, the pulse duration may be short enough to prevent material state alteration at the first point at the first point 1 and at the second point 2 at least prior to material state alteration at the distal tip(s).

In some embodiments, a plasma generation system such as shown in FIG. 1 may be further configured to apply, to the electrode(s), second follow-on current flowing through the plasma. For example, the follow-on current (e.g., flowing between the first point 1 and the second point 2) may include a first pulse of current and the second follow-on current may include a second pulse of current applied at a time later then the first pulse of current. For instance, as shown in FIG. 1, the first electrode further has a third point 3 along the electrode(s) and the second electrode further has a fourth point 4 along the electrode(s). In some embodiments, the second follow-on current may flow through the plasma from the third point 3 to the fourth point 4. In the illustrated embodiment, the third point 3 and the fourth point 4 are spaced along a length (e.g., in the length direction D_{L}) of the electrode(s) from the first point 1 and the second point 2.

In some embodiments, the second follow-on current may have a pulse duration that is short enough to prevent material state alteration of the electrode(s) at the third point 3 and at the fourth point 4. For example, follow-on current (e.g., including the second follow-on current) may be applied such that, as plasma propagates along the electrodes 1 and 2, points along the electrodes 1 and 2 do not undergo material state alteration. For instance, a pulse duration of follow-on current applied to the electrodes 1 and 2 may be short enough to prevent material state alteration of the electrode 1 and 2 at the first point 1 and the second point 2 (and/or at the third point 3 and the fourth point 4) at least until plasma propagated from the first point 1 and the second point 2 reaches a distal tip of the electrodes 1 and 2.

In some embodiments, applying the follow-on current to the electrode(s) may include propagating the plasma along a length of the electrode(s), such as described above for applying a pulse of current. For example, applying the follow-on current through the plasma may include propagating the plasma along the length of the electrodes 1 and 2 in the length direction D_{L} in FIG. 1.

According to another aspect of the present disclosure, a plasma generation system such as shown in FIG. 1 may be configured to apply, to the electrode(s), after the breakdown and before total recombination of the plasma, an amount of electrical energy sufficient to directionally propagate the plasma while keeping thermal expansion of the electrode(s) below a threshold thermal expansion amount. For example, the threshold thermal expansion amount may be based on a pressure gradient in which the electrode(s) are disposed when the amount of electrical energy is applied. It is recognized that electrical energy applied to the electrodes may form, sustain, and even propagate plasma but that thermal expansion of the electrodes may be considered and balanced. In some embodiments, follow-on current applied to the electrode(s) may have an amount of electrical energy that is sufficient to controllably directionally propagate the plasma while keeping thermal expansion of the at least two electrodes below the threshold thermal expansion amount.

According to another aspect of the present disclosure, a plasma generation system such as shown in FIG. 1 may be configured to apply follow-on current to the electrode(s) while at least distal tips of the electrode(s) are only proximate to an environment having a pressure below 300 PSI. For example, the environment of FIG. 1 may be a low-pressure environment in which pressure does not exceed 300 PSI, or at least in which plasma is not generated while pressure exceeds 300 PSI. In some embodiments, the follow-on current may be applied after breakdown and before total recombination of the plasma and/or may be sufficient to prevent total recombination of the plasma while controllably directionally propagating the plasma, such as described above. In some embodiments, the pressure may be below 175 PSI, 150 PSI, and/or below 100 PSI. It is recognized that considerations for an amount of energy delivered in an environment in which pressure does not exceed 300 PSI (or a lower amount such as 175 PSI) are significantly different from an environment in which plasma may be generated, sustained, and/or propagated with high-pressure, and thus careful consideration of energy levels may be warranted, such as described herein.

According to another aspect of the present disclosure, a plasma generation system such as shown in FIG. 1 may be configured to apply, to the electrode(s), a breakdown voltage and follow-on current that collectively include an amount of energy exceeding ⅓ J. For example, the follow-on current may be sufficient to prevent total recombination of the plasma while controllably directionally propagating the plasma such as described herein. According to various embodiments, the amount of energy may exceed 2 J, 4 J, and/or 10 J. For example, the amount of energy may be sufficient to controllably directionally propagate the plasma while keeping thermal expansion of the electrode(s) below a threshold thermal expansion amount, such as described herein. It is appreciated that ⅓ J or more may be a quantity of energy that is not desirable to apply to electrodes in high-pressure, such as given the resistance to plasma formation and propagation in high-pressure and the extent to which such an amount of energy may destroy the electrodes while in high-pressure.

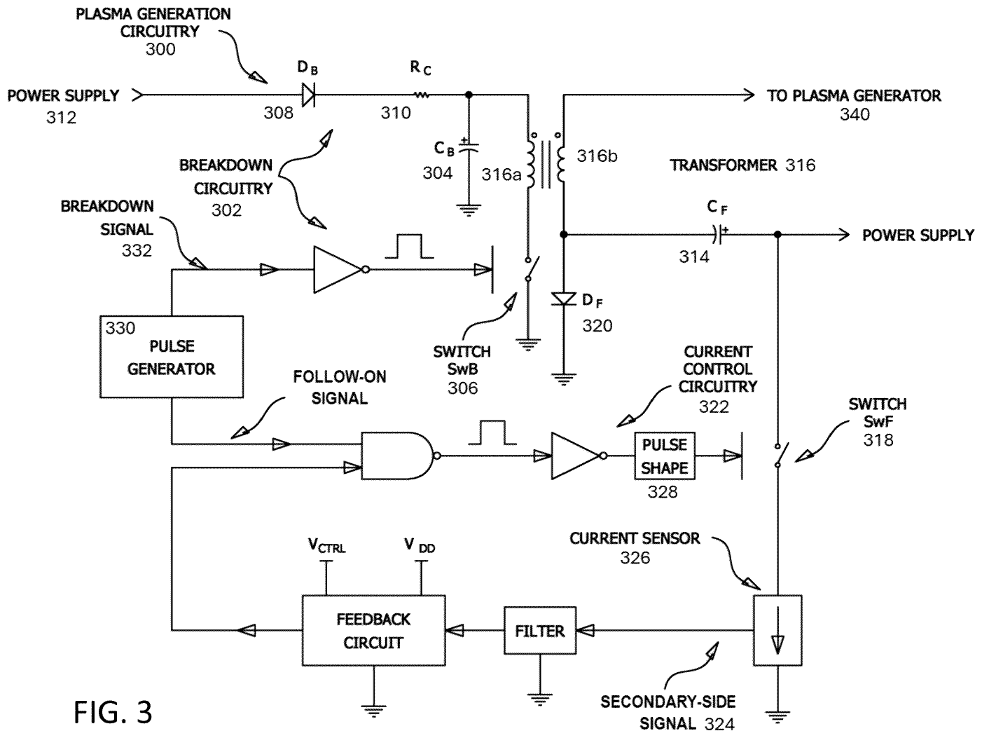

As shown in FIG. 1, the illustrated plasma generation system includes plasma generation circuitry coupled to the plasma generator, which may be configured to apply breakdown voltage and/or follow-on energy to the plasma generator. A further example of plasma generation circuitry is shown in FIG. 3 and described further herein.

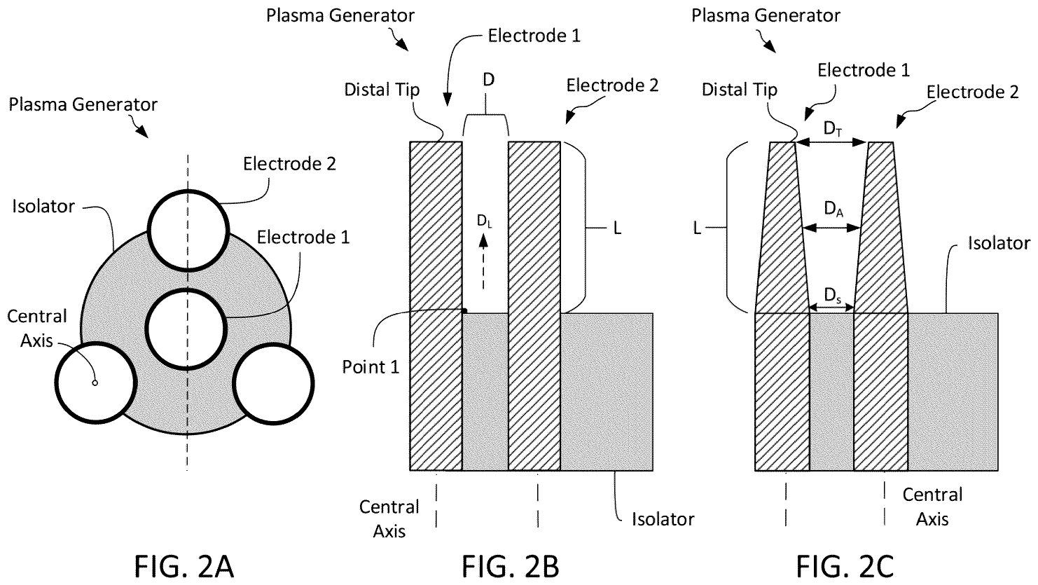

FIG. 2A illustrates a top view of an example plasma generator having an isolator spacing apart a plurality of electrodes that may be included in the plasma generation system of FIG. 1, according to some embodiments. FIG. 2B illustrates a side view of a cross-section of the plasma generator of FIG. 2A, according to some embodiments.

As shown in FIG. 2A, the plasma generator has a configuration with four electrodes in a rail configuration, with the first electrode 1 as an inner (e.g., center) electrode and the second electrode 2 among multiple outer electrodes. In other configurations, the first electrode 1 and the second electrode 2 may be the only two electrodes, either in a coaxial configuration or in a rail configuration (e.g., with the two electrodes having offset central axes). It should be appreciated that references herein to a first electrode and to a second electrode may apply to any two (or more) electrodes across which an electric potential may be applied (e.g., to achieve and/or sustain breakdown). For example, an initiation region may be where breakdown occurs and plasma formation initiates between any two electrodes between which breakdown may be configured to occur (e.g., by application of a breakdown voltage).

In the illustrated embodiment, the outer electrodes are shown partially inset into the isolator and the inner electrode is shown fully inset into the isolator, though other configurations are possible. For example, a configuration of two or more electrodes may have the electrodes fully inset, partially inset, and/or some fully inset and some partially inset. Also in the illustrated embodiment, the electrodes are shown having a rounded (e.g., circular) cross-section, though electrodes may have a different rounded or non-rounded cross-sectional shape such as an ellipse and/or a rectangle.

According to an aspect of the present disclosure, a ratio of a length of the electrode(s), from the initiation region to the distal tip, to an edge-to-edge distance between the electrode(s), along the length of the electrode(s) from the initiation region to the distal tip, may be at least 1.75:1. For example, a length of the first electrode 1, from the first point 1 to the distal tip of the first electrode 1, to an edge-to-edge distance between the first electrode 1 and the second electrode 2, along the length of the first electrode from the first point 1 to the distal tip, may be at least 1.75:1. In the illustrated cross-section of FIG. 2B, the first electrode 1 has a length L from the first point 1 to the distal tip, and the edge-to-edge distance D is between the first electrode 1 and the second electrode 2 over the length L, which may satisfy such a ratio. In some embodiments, the ratio may be at least 2:1 and/or at least 3:1. It is recognized that a relatively long electrode length may provide a large area for electrical discharge during to plasma formation, growth and/or propagation, resulting in correspondingly low electrical discharge and correspondingly concentrated wear at the distal tip(s), for a long useful life of the electrodes.

In some embodiments, the length of the electrode(s) may be from the isolator to a distal tip of the electrode(s). For example, in FIG. 2B, the first point 1 is proximate the isolator, such that the length L spans substantially from the isolator to the distal tip of the first electrode 1. For instance, the length from the isolator to the distal tip may be longer than from the first point 1 (e.g., where plasma initiates upon breakdown), depending on the configuration (e.g., where the initiation region is closer to the distal tip than shown in FIG. 2B). In some embodiments, the ratio using this length may be at least 1.75:1, at least 2:1, and/or at least 3:1.

According to another aspect of the present disclosure, a length of the electrode(s) from the initiation region to the distal dip (e.g., of the first electrode 1) may be at least 0.08 inches. In some embodiments, the length may be at least 0.12 inches and/or at least 0.16 inches. For example, the length L shown in FIG. 2B, and/or the length from the isolator to the distal tip, may take on any of these values and/or values in between. It is recognized that a relatively long electrode length may provide a large area for electrical discharge during to plasma formation, growth and/or propagation, resulting in correspondingly low electrical discharge and correspondingly concentrated wear at the distal tip(s), for a long useful life of the electrodes.

In some embodiments, the electrodes may have at least two portions elongated substantially parallel to one another in a first direction between a surface of the isolator and the distal tip. For example, the first electrode 1 and the second electrode 2 in FIG. 2B have portions elongated substantially parallel to one another in a first direction (e.g., the length direction D_{L} in FIG. 2B) between the isolator and the distal tip of the first electrode 1. In some embodiments, portions of the electrode(s) may be further elongated substantially parallel to one another in the first direction (e.g., length direction D_{L}) both above and below the initiation region (e.g., surface of the isolator). For example, portions of the first electrode 1 and the second electrode 2 are shown in FIG. 2B elongated substantially parallel to one another on a first side of the isolator, on which the distal tip of the first electrode 1 is disposed, and further elongated substantially parallel to one another on a second side of the surface of the isolator opposite to distal tip of the first electrode 1.

As used herein, “substantially parallel” as it applies to the electrodes refers to the electrodes being either parallel or within 20° of parallel. This measurement can be made based on the central axes of the electrodes or, alternatively, the facing surface portions of the electrodes; i.e., the nearest point of the electrodes to each other along their length as represented by the points on the electrodes 1 and 2 of FIG. 1.

In some embodiments, central axes of the electrodes, in the first direction (e.g., along the length direction D_{L} in FIG. 2B) may be offset from one another in a plane that is orthogonal to the first direction. For example, in FIG. 2B, a central axis of the first electrode 1 is shown offset from a central axis of the second electrode 2 in a direction that is orthogonal to the length direction D_{L}, and thus lies in a plane orthogonal to the length direction D_{L}. For instance, the first electrode 1 and the second electrode 2 may be and/or form part of a rail configuration and/or other non-coaxial configuration, though a coaxial configuration may be used in other embodiments.

According to an aspect of the present disclosure, a ratio of a propagation length of the electrode(s) to an edge-to-edge distance between the electrode(s) along the propagation length may be at least 1.75:1. For example, the propagation length may be a length of the first electrode 1 along which plasma propagates from application of a controlled pulse of energy and terminating at a distal tip of the first electrode 1. In some embodiments, the ratio may be at least 2:1. In some embodiments, the propagation length may be between a surface of the isolator and a distal tip of the electrode(s). For example, the propagation length may be from a point (e.g., the first point 1) at or proximate a surface of the isolator to the distal tip of the first electrode 1. For instance, the initiation region may be proximate the surface of the isolator, such as where the surface of the isolator provides the lowest impedance path between the electrodes prior to breakdown.

In some embodiments, central axes of the electrodes in the direction of propagation of the plasma may be offset from one another in a plane that is orthogonal to the direction of propagation of the plasma. For example, in FIG. 2B, the central axes are shown in the length direction D_{L}, along which plasma may propagate along the length of electrodes.

FIG. 2C illustrates a side view of a cross-section of an alternative example plasma generator that may be included in the plasma generation system of FIG. 1, according to some embodiments.

In the alternative example configuration in FIG. 2C, portions of the first electrode 1 and the second electrode 2 are shown tapered. It should be appreciated that both the first electrode 1 and the second electrode 2 need not be tapered as only one may be tapered, and/or the first electrode 1 and the second electrode 2 may have different tapering (e.g., at different locations along their lengths, by different amounts, and/or in different shape, such as linearly and non-linearly, both above and below the initiation region).

Notwithstanding tapering, in the illustrated embodiment, portions of the electrodes extend substantially parallel to one another both above and below a surface of the isolator as in FIG. 2B. For instance, at least central axes of the illustrated electrodes are substantially parallel to one another in FIG. 2C. In some embodiments, as an alternative or in addition to central axes of the electrodes being substantially parallel, edges of the electrodes may be (e.g., even when tapered) substantially parallel to one another, such that at least portions of the electrodes are substantially parallel.

In contrast to the example of FIG. 2B, in FIG. 2C, edge-to-edge distance between the electrodes is nonuniform along the length L. According to various embodiments, an edge-to-edge distance in a ratio of length to distance may be a shortest edge-to-edge distance between the electrodes along the length, a longest edge-to-edge distance between the at least two electrodes along the length of the at least two electrodes from the initiation region to the distal tip, and/or an average edge-to-edge distance between the at least two electrodes along the length of the at least two electrodes from the initiation region to the distal tip. In the example of FIG. 2B, each of these edge-to-edge distances may be the same distance D, whereas in FIG. 2C, these distances may be different.

In some embodiments, the edge-to-edge distance may be a shortest edge-to-edge distance between the electrodes along the length of the electrode(s) from the initiation region to the distal tip, from the first point 1 to the distal tip, along the propagation length, and/or along the length where the electrodes extend substantially parallel to one another both above and below a surface of the isolator. For example, in FIG. 2C, the shortest edge-to-edge distance along any of these lengths is the distance D_{S}. While the distance D_{S} coincides with the initiation region in the illustrated embodiment, there may be cases where the distance D_{S} does not so coincide, such as where the length is both above and below the surface of the isolator and the closest edge-to-edge distance does not provide the lowest impedance between the electrodes prior to breakdown.

In some embodiments, the edge-to-edge distance may be a longest edge-to-edge distance between the electrodes along the length of the electrode(s) from the initiation region to the distal tip, from the first point 1 to the distal tip, along the propagation length, and/or along the length where the electrodes extend substantially parallel to one another both above and below a surface of the isolator. For example, in FIG. 2C, the longest edge-to-edge distance along any of these lengths is the distance D_{T}. While the distance D_{T} coincides with the distal tips of the electrodes in the illustrated embodiment, there may be cases where the distance D_{T} does not so coincide, such as where tapering of the electrode(s) does not space the edges of the electrodes farthest apart at the distal tips.

In some embodiments, the edge-to-edge distance may be an average edge-to-edge distance between the electrodes along the length of the electrode(s) from the initiation region to the distal tip, from the first point 1 to the distal tip, along the propagation length, and/or along the length where the electrodes extend substantially parallel to one another both above and below a surface of the isolator. For example, in FIG. 2C, the average edge-to-edge distance along any of these lengths is, at most, the distance D_{A}. For instance, in the case of length of the electrodes extending parallel to one another both above and below the isolator surface, the average edge-to-edge distance is less than the distance D_{A} due to the length below the isolator surface at which the edge-to-edge spacing is shorter than the distance D_{A}. While the distance D_{A}, for lengths starting at least at the isolator surface in FIG. 2B, coincides with the midpoint of the length L in the illustrated embodiment, there may be cases where the distance D_{A} does not so coincide, such as where tapering of the electrode(s) is nonlinear.

FIG. 3 illustrates example plasma generation circuitry 300 that may be configured to apply one or more subsequent controlled pulses of electrical energy to a plasma generator that may be included in the plasma generation system of FIG. 1, according to some embodiments.

In FIG. 3, the plasma generation circuitry 300 includes breakdown circuitry 302, which may be configured to apply a breakdown voltage to electrodes (e.g., electrodes 1 and 2 of FIGS. 1-2C) of a plasma generator 340 using energy stored in an energy storage device (e.g., other than the energy storage device used for applying follow-on energy but not limited thereto). For example, in FIG. 3, the breakdown circuitry 302 includes a breakdown capacitance 304 coupled to a breakdown switch SwB 306 via a primary coil 316a of a transformer 316. For instance, upon closing of the breakdown switch 306, energy stored in the breakdown capacitance 304 may pass through the primary coil 316a and thereby draw current through a secondary coil 316b of the transformer 316 to the plasma generator, which may produce a voltage across the secondary coil 316b sufficient to cause breakdown (e.g., due to a turns ratio of the transformer and the rate at which current is changing at least in the secondary coil 316b). In the illustrated embodiment, a pulse generator 330 is further included to produce a breakdown signal 332 applied to the breakdown switch 306 to controllably initiate breakdown.

In the illustrated embodiment, breakdown capacitance 304 may be charged via a breakdown diode 308 and a charging resistor 310 from a power supply 312. For example, after breakdown, the breakdown switch 306 may be opened to permit recharging of the breakdown capacitance 304 without the charging current passing through the transformer to the switch 306. In other embodiments, charging current from the power supply 312 may be applied to the primary coil 316a through a diode that bypasses the switch, such that the switch may remain closed while charging the capacitance.

In some embodiments, applying a breakdown voltage to the electrode(s) of a plasma generator may include applying the breakdown voltage from an energy storage device to the electrode(s) via a transformer. For example, as shown in FIG. 3, the transformer further couples a follow-on capacitance 314 to the plasma generator 340 on the secondary side. In some embodiments, upon closing of the breakdown switch 306, current may flow from the follow-on capacitance 314 through the secondary coil 316b of the transformer 316 to the plasma generator 340. While the illustrated embodiment shows application of breakdown energy to the primary coil 316a μsing a different energy storage device than application of breakdown energy to the secondary coil 316b, a shared energy storage device may be used to apply energy to both the primary coil 316a and the secondary coil 316b in other embodiments, as the present disclosure is not so limited.

Similarly, in some embodiments, applying follow-on electrical energy to the electrode(s) may include applying the follow-on electrical energy from an energy storage device to the electrode(s) via a transformer. For example, after breakdown, additional current may flow from the follow-on capacitance 314 to the plasma generator 340 via the secondary coil 316b of the transformer 316, which is the same path as the breakdown voltage in the illustrated embodiment. In other embodiments, separate energy storage devices (e.g., capacitances) may be used for application of breakdown voltage and follow-on energy.

In some embodiments, the transformer 316 may have a saturable core. For example, the transformer 316 may have a low turns ratio (e.g., 37:1) to produce a low breakdown voltage and saturate upon application of sufficient current through the secondary coil 316b. For instance, a transformer core may be at least partially saturated when the secondary coil 316b inductance becomes significantly less inductive due to the core (e.g., ferromagnetic material about which the secondary coil is wound) taking on behavior of air, and/or the secondary coil 316b becoming substantially decoupled from the primary coil.

In some embodiments, the (e.g., saturable) core of the transformer 316 may be saturated by application of the breakdown voltage and may remain at least partially saturated at least through (e.g., controlled) application of electrical energy following breakdown. For example, by keeping at least partial saturation of the transformer 316 at least through application of follow-on electrical energy, current applied to the secondary coil 316b during at least partial saturation may encounter a low inductance and produce a low voltage drop across the secondary coil 316b while passing through to the plasma generator 340 to flow through the plasma.

In some embodiments, applying the breakdown voltage and/or applying the follow-on current may include closing a switching element coupled in a path from the plasma generator that includes an energy storage device and a transformer. For example, in FIG. 3, the plasma generation circuitry 300 further includes a switch SwF 318 coupled in a path from the plasma generator 340 through the secondary coil 316b of the transformer 316 to the follow-on capacitance 314 and further to ground via the switch 318. In other embodiments, the switch 318 may be coupled between the plasma generator 340 and the secondary coil 316b of the transformer 316, and/or between the secondary coil 316b of the transformer 316 and an energy storage device. While a single switch 318 is shown in FIG. 3, it should be appreciated that multiple switches may be included in a switching element, such as multiple series and/or parallel connected switches. According to various embodiments, a switching element may include an isolated gate bipolar transistor (IGBT), a thyristor such as a MOS-controlled thyristor (MCT).

In the illustrated embodiment, a diode 320 is further coupled to a point between the follow-on capacitance 314 and the secondary coil 316b of the transformer 316, such as to create a reference voltage point (e.g., close to 1 V above ground in FIG. 3) between the follow-on capacitance 314 and the secondary coil 316b while the switch 318 is closed. Also shown in FIG. 3, a power supply 336 is coupled to the follow-on capacitance 314. For example, a blocking diode (not shown) may be coupled between the follow-on capacitance 314 and the power supply 336 to permit charging of the follow-on capacitance 314 and to block the flow of electrical energy from the follow-on capacitance 314 to the power supply 336.

In some embodiments, the plasma generation circuitry may be configured to actively control application of follow-on energy to the plasma generator. For example, in FIG. 3, the plasma generation circuitry 300 further includes current control circuitry 322. In the illustrated embodiment, the current control circuitry 322 includes a feedback loop incorporating feedback from a current sensor 326 into a secondary-side signal 324. For instance, the feedback loop may be configured to regulate an amount of current flowing through the secondary coil 316b (e.g., corresponding to current flowing through the plasma) by comparing a sensed amount of current flowing through the switch 318 to a threshold current level (e.g., set by a control voltage VCTRL), and enable the secondary side signal to turn on the switch 318 using a follow-on control signal 334 based on the sensed amount of current. In the illustrated embodiment, pulse shaping 328 is also applied, such as may be used to control a rise time and/or fall time of a pulse of follow-on current.

It should be appreciated that other plasma generation circuitry configurations may be used depending on the application. For example, where a sufficiently low breakdown voltage may be used (e.g., where a treated ceramic isolator surface provides for a very low breakdown voltage), the breakdown voltage and/or follow-on current may be delivered directly to the plasma generator from an energy storage device, such as without first passing through an inductance. For instance, an energy storage device may be coupled directly to a plasma generator by a switching element.

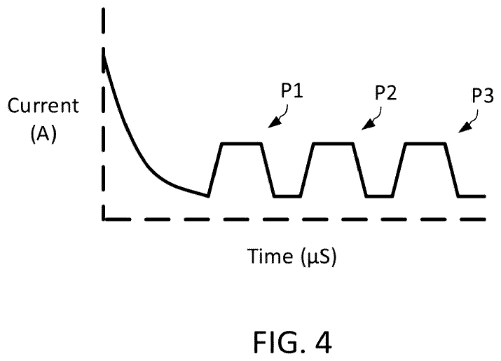

FIG. 4 illustrates an example application of pulses of electrical energy following breakdown in the plasma generation system of FIG. 1, according to some embodiments.

As shown in FIG. 4, breakdown may be followed by a decline in current through the plasma, such as due to at least partial plasma recombination. In the illustrated embodiment, a sequence of at least three pulses of current P1, P2, and P3 are controllably applied (e.g., additional pulses may be applied after the illustrated timeframe). For example, the current pulses shown in FIG. 4 may be applied using circuitry shown in FIG. 3, though other circuitry configurations could be used. It should be appreciated that fewer pulses than illustrated may be applied, depending on the embodiment.

In some embodiments, applying pulses of electrical energy may include alter a rate of current decay through the plasma with respect to current decay following breakdown without the pulses of electrical energy. For example, as shown in FIG. 4, the current decay following breakdown is altered by the three pulses to produce a higher current than would be flowing through the plasma following breakdown without applying the pulses. For instance, application of pulses may include using at least one active circuit element, such as a switching element.

In some embodiments, at least two pulses of electrical energy may be applied. For example, in FIG. 4, each pulse is shown having a same peak current value, though in other embodiments pulses may have different current values (e.g., to provide different amounts of electrical energy). In some embodiments, a second pulse (e.g., P2) may be applied following a first pulse (e.g., P1) with electrical energy sufficient to further propagate the plasma toward a distal tip of the electrode(s) (e.g., the distal tip of electrode 1). It should be appreciated that while square pulses (e.g., trapezoidal pulses due to nonzero rise and fall times in a practical implementation) are shown in FIG. 4, other pulse shapes may be used such as triangle and/or sinusoidal pulses.

In some embodiments, a first pulse (e.g., P1) may be applied to the electrode(s) (e.g., at a first pair of points) and a second pulse (e.g., P2) may be applied to the electrode(s) (e.g., at a second pair of points closer to the distal tips than the first pair of points are). For example, the second pulse may be applied through the plasma farther along a length of the electrode(s) (e.g., in length direction D_{L} in FIG. 1) as part of propagating the plasma along the length of the electrode(s).

In some embodiments, applying a subsequent pulse of current may be before a next application of the breakdown voltage to the electrode(s). For example, as shown in FIG. 4, the current through the plasma does not rise to its post-breakdown decay level before application of the illustrated pulses. It should be appreciated that some at least partial recombination of the plasma may occur prior to at least some applied pulses, which may result in a breakdown voltage lower than the applied breakdown voltage being applied (e.g., using a voltage across the secondary coil of the transformer, which may become at least partially unsaturated) before at least some of the applied pulses.

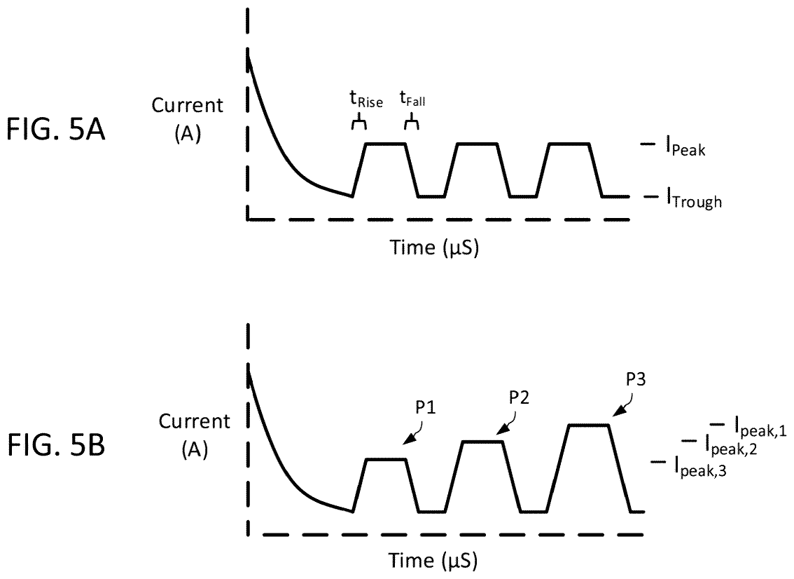

FIG. 5A illustrates example application of follow-on current following breakdown in the plasma generation system of FIG. 1, according to some embodiments.

As shown in FIG. 5A, breakdown may be followed by a decline in current through the plasma, such as due to at least partial plasma recombination. In the illustrated embodiment, a sequence of at least three pulses of follow-on current are applied (e.g., additional pulses may be applied after the illustrated timeframe). For example, the follow-on current pulses shown in FIG. 5A may be applied using circuitry shown in FIG. 2, though other circuitry configurations could be used. It should be appreciated that fewer pulses than illustrated may be applied, depending on the embodiment.

In some embodiments, applying follow-on current may include altering a rate of current decay through the plasma with respect to current decay following breakdown without the follow-on current. For example, as shown in FIG. 5A, the current decay following breakdown is altered by the three pulses of follow-on current. In some embodiments, altering the rate of current decay may include actively applying follow-on current to produce a higher current than would be flowing through the plasma following breakdown without applying the follow-on current. For example, in FIG. 5A, current flowing through the plasma is higher at each illustrated pulse than the current would be according to the decay curve that precedes the pulses. For instance, application of follow-on current may include using at least one active circuit element, such as a switching element.

In some embodiments, applying follow-on current may include applying, to the electrode(s), at least two pulses of current (e.g., having at least the peak current described herein as exceeding 450 A). For example, in FIG. 5A, each pulse is shown having a peak current I_{Peak}, which is the same for each pulse in FIG. 5A, though need not be (e.g., see FIG. 5B). For instance, in FIG. 5A, each illustrated pulse may have a peak current I_{Peak} exceeding 450 A, and at least one of the pulses shown in FIG. 5A may reach the peak current I_{Peak} at least two microseconds following breakdown. It should be appreciated that while square pulses (e.g., trapezoidal pulses due to nonzero rise and fall times in a practical implementation) are shown in FIG. 5A, other pulse shapes may be used such as triangle and/or sinusoidal pulses.

In some embodiments, applying the follow-on current and/or pulse of current may be before a next application of the breakdown voltage to the electrode(s). For example, as shown in FIG. 5A, the current through the plasma does not rise to its post-breakdown decay level before application of the illustrated pulses. It should be appreciated that some at least partial recombination of the plasma may occur prior to at least some applied follow-on current, which may result in a breakdown voltage lower than the applied breakdown voltage being applied (e.g., using a voltage across the secondary coil of the transformer, which may become at least partially unsaturated) before at least some of the applied follow-on current.

According to another aspect of the present disclosure, a follow-on current may have a pulse having a rise time shorter than 10 μs. For example, the rise time may be shorter than 5 μs, and/or shorter than 3 μs. For example, in FIG. 5A, the first illustrated pulse has a rise time t_{Rise} and a fall time t_{Fall}. In some embodiments, the rise time t_{Rise} and/or the fall time t_{Fall} may be controlled to produce a pulse of follow-on current that contributes a sufficient Lorentz force (e.g., for plasma propagation) and/or at least prevents total recombination of the plasma while limiting time during which a given point along the electrodes is exposed to wear. It is recognized that rise and/or fall times of pulses of follow-on current may be a useful tool for balancing wear on the electrodes with beneficial application of electrical energy to the electrodes.

In some embodiments, at least two pulses of current, including a pulse having the rise time and/or the fall time (e.g., shorter than 10 μs, and/or shorter than 5 μs), may be applied at a time at least two microseconds following breakdown. For example, in FIG. 5A, the first illustrated pulse may be applied at a time at least two microseconds following breakdown and include such a short rise time and/or fall time. Alternatively or additionally, other ones of the illustrated pulses may be applied at a time at least two microseconds following breakdown and include such a short rise time and/or fall time. In the illustrated embodiment, each pulse is shown having the same rise time and fall time, though that need not be the case (e.g., see FIG. 5B).

In some embodiments, follow-on current including a pulse having such a short rise time and/or fall time may be delivered using circuitry described herein including in connection with FIG. 2. For example, the follow-on current may be applied from an energy storage device via a transformer having a saturable core, and the core may remain at least partially saturated at least through application of the follow-on current. In some embodiments, pulse shaping and/or current monitoring feedback may be used to achieve a desired rise time and/or fall time. In some embodiments, a switching element coupled in a path from the plasma generator that includes the energy storage device and the transformer.

In some embodiments, applying follow-on current through the plasma including such a short rise time and/or fall time may further include propagating the plasma along a length of the electrodes, such as described herein. For example, controlling the rise and/or fall time may be useful in achieving a Lorentz force for propagating the plasma in a controllable manner and while limiting wear at any point along the electrodes.

In some embodiments, at least distal tips of the electrodes may be only proximate to an environment having a pressure below 300 PSI (or below 175 PSI, or below 150 PSI) while the follow-on current (e.g., a pulse thereof having such a short rise and/or all time) is applied.

In some embodiments, at least two pulses of follow-on current (e.g., the three illustrated pulses) may (e.g., alone or in combination with the breakdown voltage) contain an amount of energy sufficient to controllably propagate plasma along the electrodes without causing beyond a threshold amount of thermal expansion, such as described herein.

In some embodiments, as an alternative or in addition to having a relatively short rise time and/or fall time, a pulse of follow-on current such as shown in FIG. 5A may have a current rate-of-change with an absolute value exceeding 90 A/μs (e.g., exceeding 130 A/μs). For example, the first illustrated pulse is shown changing from a low current level I_{Trough} to the peak current level I_{Peak} linearly over a rise time t_{Rise}, resulting in a current rate-of-change over the rise time t_{Rise} of (I_{Peak}−I_{Trough})/t_{Rise}. Similarly, the illustrated fall time t_{Fall} results in a current rate of change over the fall time t_{Fall} Of (I_{Trough}−I_{Peak})/t_{Fall}. While the current rates-of-change in the illustrated example have opposite signs for rise and fall, they have a same absolute value. It should be appreciated that a current rate-of-change may be instantaneous and/or derived from a non-linear change in current (e.g., a sinusoidal peak) such as using a slope of a tangent line. It should be further appreciated that a current rate-of-change may have a different absolute value for a rise time of a pulse and for a fall time of a pulse, such as where a pulse is asymmetrical with time as compared to the example shown in FIG. 5A.

FIG. 5B illustrates an alternative example application of follow-on current following breakdown in the plasma generation system of FIG. 1, according to some embodiments.

In some embodiments, pulses of follow-on current may have different peak currents. For example, in FIG. 5B, a first pulse P1 is followed by a second pulse P2 having a second peak current I_{peak,2} that is higher than a first peak current I_{peak,1} of the first pulse P1. For example, the pulses of follow-on current may, at least for some pulses in a follow-on sequence, increase in peak current over time.

In some embodiments, a first follow-on current applied to the electrode(s) (e.g., at a first pair of points) may include the first pulse P1 and a second follow-on current applied at to the electrode(s) (e.g., at a second pair of points closer to the distal tips than the first pair of points are) may include the second pulse P2. For example, the second follow-on current may be applied through the plasma farther along a length of the electrode(s) (e.g., in length direction D_{L} in FIG. 1) as part of propagating the plasma along the length of the electrode(s).

In some embodiments, more than two pulses of follow-on current may be applied before a next application of the breakdown voltage. For example, in FIG. 3, the second pulse P2 is followed by a third pulse P3. In the illustrated embodiment, the third pulse P3 has a third peak current I_{peak,3} that is shown higher than the first peak current I_{peak,1} and the second peak current I_{peak,2}, though in other embodiments the sequence of pulses may differ in relative peak current. For instance, the second pulse P2 may have a peak current higher than the first pulse P1 and the third pulse P3.

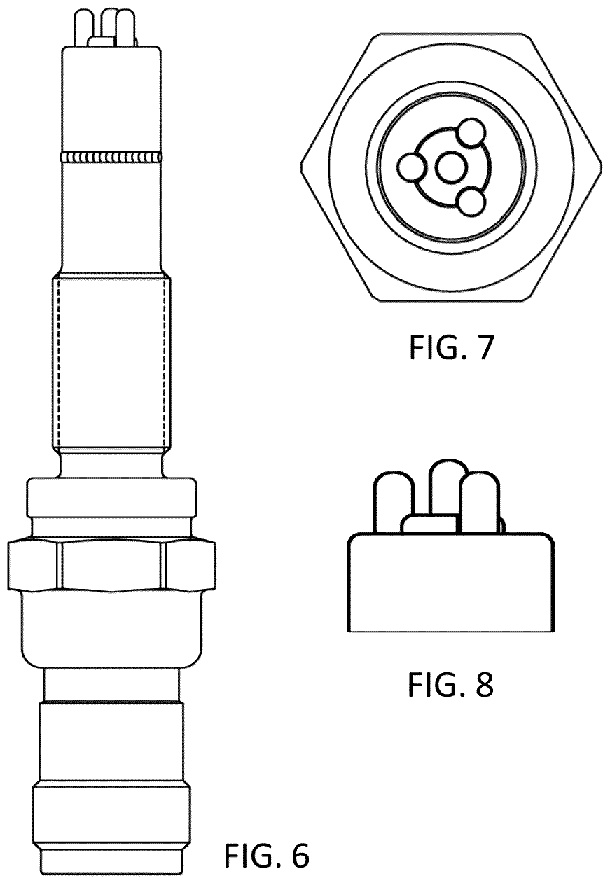

FIG. 6 illustrates a side view of an example igniter that may be included as at least a portion of a plasma generator in the plasma generation system of FIG. 1. FIG. 7 depicts an end (top) view of the igniter of FIG. 6.

In the illustrated embodiment, the igniter has a plurality of electrodes including a central, anode electrode and an outer, cathode electrode extending from the igniter housing (shell) and separated from the anode electrode by an isolator. The illustrated igniter has a rail configuration with multiple cathode electrodes extending from the cathode shell around the anode electrode. In some embodiments, the illustrated igniter may be coupled to ignition circuitry (e.g., FIG. 3) to receive electrical energy for plasma generation, growth, and/or propagation along the igniter (e.g., upward in FIG. 6). In some embodiments, the illustrated igniter may be suitable for use in low pressure environments, such as in aircraft engine environments, for example at flight altitude.

Also in the illustrated igniter, the electrodes have rounded portions proximate the distal tips, though it should be appreciated that the electrodes may not be rounded in other embodiments.

FIG. 8 shows an alternative firing end of the igniter of FIG. 6 wherein the cathode electrodes have a different exposed length from the isolator and shell than that of the center anode electrode.

The foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

### Inventive Aspects

The following paragraphs are statements defining various aspects of the invention in claim format for present or future use as patent claims. These paragraphs represent at least some of the inventive aspects for which protection is sought.

1. A plasma generation system, comprising:
a plasma generator, comprising:
   at least two electrodes; and
   an isolator spacing apart the at least two electrodes; and
circuitry configured to:
   apply, across the at least two electrodes, a breakdown voltage sufficient to induce breakdown between the at least two electrodes, resulting in formation of plasma in an initiation region; and
   apply, across the at least two electrodes, at least one controlled pulse of electrical energy sufficient to propagate the plasma from the initiation region toward a distal tip of the at least two electrodes,
   wherein a ratio of a length of the at least two electrodes, from the initiation region to the distal tip, to an edge-to-edge distance between the at least two electrodes, along the length of the at least two electrodes from the initiation region to the distal tip, is at least 1.75:1.

2. The plasma generation system of inventive aspect 1, wherein the at least one subsequent pulse of electrical energy comprises at least two pulses of electrical energy.

3. The plasma generation system of inventive aspect 1 or 2, wherein the circuitry comprises an active circuit component configured to apply the at least one subsequent pulse of electrical energy across the first and second electrodes.

4. The plasma generation system of any one of inventive aspects 1 to 3, wherein the ratio is at least 2:1.

5. The plasma generation system of any one of inventive aspects 1 to 4, wherein the edge-to-edge distance is selected from a group consisting of:
a shortest edge-to-edge distance between the at least two electrodes along the length of the at least two electrodes from the initiation region to the distal tip;
a longest edge-to-edge distance between the at least two electrodes along the length of the at least two electrodes from the initiation region to the distal tip; and
an average edge-to-edge distance between the at least two electrodes along the length of the at least two electrodes from the initiation region to the distal tip.

6. The plasma generation system of any one of inventive aspects 1 to 4, wherein the edge-to-edge distance is a shortest edge-to-edge distance between the at least two electrodes along the length of the at least two electrodes from the initiation region to the distal tip.

7. The plasma generation system of any one of inventive aspects 1 to 4, wherein the edge-to-edge distance is a longest edge-to-edge distance between the at least two electrodes along the length of the at least two electrodes from the initiation region to the distal tip.

8. The plasma generation system of any one of inventive aspects 1 to 4, wherein the edge-to-edge distance is an average edge-to-edge distance between the at least two electrodes along the length of the at least two electrodes from the initiation region to the distal tip.

9. The plasma generation system of any one of inventive aspects 1 to 8, wherein the at least two electrodes extend at least from a surface of the isolator to the distal tip, and the initiation region is between the surface of the isolator and the distal tip.

10. The plasma generation system of inventive aspect 9, wherein the at least two electrodes have at least two portions elongated substantially parallel to one another in a first direction between the surface of the isolator and the distal tip.

11. The plasma generation system of inventive aspect 10, wherein the at least two portions of the at least two electrodes are further elongated substantially parallel to one another in the first direction both above and below the surface of the isolator.

12. The plasma generation system of inventive aspect 10 or 11, wherein central axes of at least two electrodes in the first direction are offset from one another in a plane that is orthogonal to the first direction.

13. The plasma generation system of any one of inventive aspects 1 to 12, wherein, prior to breakdown, an impedance between the at least two electrodes in the initiation region is a lowest impedance between the at least two electrodes.

14. The plasma generation system of any one of inventive aspects 1 to 13, wherein the isolator comprises ceramic, and the initiation region is located proximate a surface of the ceramic.

15. The plasma generation system of any one of inventive aspects 1 to 14, wherein the circuitry comprises:
an inductance; and
an energy storage device configured to apply the breakdown voltage and the at least one controlled pulse of electrical energy across the at least two electrodes via the inductance.

16. The plasma generation system of inventive aspect 15, wherein:
the inductance comprises a transformer having a saturable core;
the energy storage device is configured to apply the breakdown voltage and the at least one controlled pulse of electrical energy across the at least two electrodes via the transformer; and
the transformer is configured to maintain saturation of the saturable core between application of the breakdown voltage and application of the at least one controlled pulse of electrical energy.

17. The plasma generation system of inventive aspect 15 or 16, wherein the circuitry further comprises:
a switching element coupled in a path from the at least two electrodes that includes the energy storage device and the inductance; and
a controller configured to close the switching element to pass the at least one controlled pulse of electrical energy from the energy storage device to the inductance for applying across the at least two electrodes.

18. The plasma generation system of any one of inventive aspects 1 to 17, wherein the circuitry is configured to apply the breakdown voltage and the at least one controlled pulse of electrical energy only while at least the distal tip of the at least two electrodes is only proximate to an environment having a peak pressure below 300 pounds per square inch (PSI).

19. An ignition system, comprising:
an igniter, comprising:
   a first electrode and a second electrode; and
   an isolator spacing apart the first electrode and the second electrode; and
circuitry configured to:
   apply, across the first electrode and the second electrode, a breakdown voltage sufficient to induce breakdown between a first point along the first electrode and a second point along the second electrode, resulting in formation of plasma between the first point and the second point; and
   apply, across the first electrode and the second electrode, a controlled pulse of electrical energy sufficient to propagate the plasma from the first point toward a distal tip of the first electrode,
   wherein a ratio of a length of the first electrode, from the first point to the distal tip, to an edge-to-edge distance between the first electrode and the second electrode, along the length of the first electrode from the first point to the distal tip, is at least 1.75:1.

20. The ignition system of inventive aspect 19, wherein the circuitry is further configured to apply, across the first electrode and the second electrode, after applying the controlled pulse of electrical energy, a second pulse of electrical energy sufficient to further propagate the plasma toward the distal tip of the first electrode.

21. The ignition system of inventive aspect 19 or 20, wherein the circuitry comprises an active circuit component configured to apply the controlled pulse of electrical energy across the first electrode and the second electrode.

22. The ignition system of any one of inventive aspects 19 to 21, wherein the ratio is at least 2:1.

23. The ignition system of any one of inventive aspects 19 to 22, wherein the edge-to-edge distance is selected from a group consisting of:
a shortest edge-to-edge distance between the first electrode and the second electrode along the length of the first electrode from the first point to the distal tip;
a longest edge-to-edge distance between the first electrode and the second electrode along the length of the first electrode from the first point to the distal tip; and
an average edge-to-edge distance between the first electrode and the second electrode along the length of the first electrode from the first point to the distal tip.

24. The ignition system of any one of inventive aspects 19 to 22, wherein the edge-to-edge distance is a shortest edge-to-edge distance between the first electrode and the second electrode along the length of the first electrode from the first point to the distal tip.

25. The ignition system of any one of inventive aspects 19 to 22, wherein the edge-to-edge distance is a longest edge-to-edge distance between the first electrode and the second electrode along the length of the first electrode from the first point to the distal tip.

26. The ignition system of any one of inventive aspects 19 to 22, wherein the edge-to-edge distance is an average edge-to-edge distance between the first electrode and the second electrode along the length of the first electrode from the first point to the distal tip.

27. The ignition system of any one of inventive aspects 19 to 26, wherein the first electrode and the second electrode extend at least from a surface of the isolator to the distal tip, and the first point and the second point are between the surface of the isolator and the distal tip.

28. The ignition system of inventive aspect 27, wherein the first electrode and the second electrode have portions elongated substantially parallel to one another in a first direction between the surface of the isolator and the distal tip.

29. The ignition system of inventive aspect 28, wherein the portions of the first electrode and the second electrode are further elongated substantially parallel to one another in the first direction on a side of the surface of the isolator opposite the distal tip.

30. The ignition system of inventive aspect 28 or 29, wherein a central axis of the first electrode in the first direction and a central axis of the second electrode in the first direction are offset from one another in a plane that is orthogonal to the first direction.

31. The ignition system of any one of inventive aspects 19 to 30, wherein, prior to breakdown, an impedance between the first point and the second point is a lowest impedance between the first electrode and the second electrode.

32. The ignition system of any one of inventive aspects 19 to 31, wherein the isolator comprises ceramic, and the first point and the second point are located proximate a surface of the ceramic.

33. The ignition system of any one of inventive aspects 19 to 32, wherein the circuitry comprises:
an inductance; and
an energy storage device configured to apply the breakdown voltage and the controlled pulse of electrical energy across the first electrode and the second electrode via the inductance.

34. The ignition system of inventive aspect 33, wherein:
the inductance comprises a transformer having a core;
the energy storage device is configured to apply the breakdown voltage and the controlled pulse of electrical energy across the first electrode and the second electrode via the transformer; and
the transformer is configured to maintain saturation of the core between application of the breakdown voltage and application of the controlled pulse of electrical energy.

35. The ignition system of inventive aspect 33 or 34, wherein the circuitry further comprises:
a switch coupled in a path from the first electrode and the second electrode that includes the energy storage device and the inductance; and
a switch controller configured to close the switch to pass the controlled pulse of electrical energy from the energy storage device to the inductance for applying across the first electrode and the second electrode.

36. The ignition system of any one of inventive aspects 19 to 35, wherein the circuitry is configured to apply the breakdown voltage and the controlled pulse of electrical energy only while at least the distal tip of the first electrode is proximate to an environment having a peak pressure below 300 pounds per square inch (PSI).

37. A plasma generation system, comprising:
a plasma generator, comprising:
   at least two electrodes; and
   an isolator spacing apart the at least two electrodes; and
circuitry configured to:
   apply, across the at least two electrodes, a breakdown voltage sufficient to induce breakdown between the at least two electrodes, resulting in formation of plasma in an initiation region; and
   apply, across the at least two electrodes, at least one controlled pulse of electrical energy sufficient to propagate the plasma from the initiation region toward a distal tip of the at least two electrodes,
   wherein a length of the at least two electrodes, from the initiation region to the distal tip, is at least 0.08 inches.

38. The plasma generation system of inventive aspect 37, wherein the length is at least 0.12 inches.

39. The plasma generation system of inventive aspect 37, wherein the length is at least 0.16 inches.

40. The plasma generation system of any one of inventive aspects 37 to 39, wherein the at least one controlled pulse of electrical energy comprises at least two pulses of electrical energy.

41. The plasma generation system of any one of inventive aspects 37 to 40, wherein the circuitry comprises an active circuit component configured to apply the at least one controlled pulse of electrical energy across the at least two electrodes.

42. The plasma generation system of any one of inventive aspects 37 to 41, wherein the at least two electrodes extend at least from a surface of the isolator to the distal tip, and the initiation region is between the surface of the isolator and the distal tip.

43. The plasma generation system of inventive aspect 42, wherein the at least two electrodes have at least two portions elongated substantially parallel to one another in a first direction between the surface of the isolator and the distal tip.

44. The plasma generation system of inventive aspect 43, wherein the at least two portions of the at least two electrodes are further elongated substantially parallel to one another in the first direction both above and below the surface of the isolator.

45. The plasma generation system of inventive aspect 43 or 44, wherein central axes of at least two electrodes in the first direction are offset from one another in a plane that is orthogonal to the first direction.

46. The plasma generation system of any one of inventive aspects 37 to 45, wherein, prior to breakdown, an impedance between the at least two electrodes in the initiation region is a lowest impedance between the at least two electrodes.

47. The plasma generation system of any one of inventive aspects 37 to 46, wherein the isolator comprises ceramic, and the initiation region is located proximate a surface of the ceramic.

48. The plasma generation system of any one of inventive aspects 37 to 47, wherein the circuitry comprises:
an inductance; and
an energy storage device configured to apply the breakdown voltage and the at least one pulse of controlled electrical energy across the at least two electrodes via the inductance.

49. The plasma generation system of inventive aspect 48, wherein:
the inductance comprises a transformer having a saturable core;
the energy storage device is configured to apply the breakdown voltage and the at least one controlled pulse of electrical energy across the at least two electrodes via the transformer; and
the transformer is configured to maintain saturation of the saturable core between application of the breakdown voltage and application of the at least one controlled pulse of electrical energy.

50. The plasma generation system of inventive aspect 48 or 49, wherein the circuitry further comprises:
a switching element coupled in a path from the at least two electrodes that includes the energy storage device and the inductance; and
a controller configured to close the switching element to pass the at least one controlled pulse of electrical energy from the energy storage device to the inductance for applying across the at least two electrodes.

51. The plasma generation system of any one of inventive aspects 37 to 50, wherein the circuitry is configured to apply the breakdown voltage and the at least one controlled pulse of electrical energy only while at least the distal tip of the at least two electrodes is proximate to an environment having a peak pressure below 300 pounds per square inch (PSI).

52. An ignition system, comprising:
an igniter, comprising:
   a first electrode and a second electrode; and
   an isolator spacing apart the first electrode and the second electrode; and
circuitry configured to:
   apply, across the first electrode and the second electrode, a breakdown voltage sufficient to induce breakdown between the first electrode and the second electrode, resulting in formation of plasma between the first electrode and the second electrode; and
   apply, across the first electrode and the second electrode, a controlled pulse of electrical energy sufficient to propagate the plasma along a propagation length of the first electrode, the propagation length terminating at a distal tip of the first electrode,
   wherein a ratio of the propagation length of the first electrode to an edge-to-edge distance between the first electrode and the second electrode, along the propagation length of the first electrode, is at least 1.75:1.

53. The ignition system of inventive aspect 52, wherein the circuitry is further configured to apply, across the first electrode and the second electrode, after applying the controlled pulse of electrical energy, a second pulse of electrical energy sufficient to further propagate the plasma toward the distal tip of the first electrode.

54. The ignition system of inventive aspect 52 or 53, wherein the circuitry comprises an active circuit component configured to apply the controlled pulse of electrical energy across the first electrode and the second electrode.

55. The ignition system of any one of inventive aspects 52 to 54, wherein the ratio is at least 2:1.

56. The ignition system of any one of inventive aspects 52 to 55, wherein the edge-to-edge distance is selected from a group consisting of:
a shortest edge-to-edge distance between the first electrode and the second electrode along the propagation length;
a longest edge-to-edge distance between the first electrode and the second electrode along the propagation length; and
an average edge-to-edge distance between the first electrode and the second electrode along the propagation length.

57. The ignition system of any one of inventive aspects 52 to 55, wherein the edge-to-edge distance is a shortest edge-to-edge distance between the first electrode and the second electrode along the propagation length.

58. The ignition system of any one of inventive aspects 52 to 55, wherein the edge-to-edge distance is a longest edge-to-edge distance between the first electrode and the second electrode along the propagation length.

59. The ignition system of any one of inventive aspects 52 to 55, wherein the edge-to-edge distance is an average edge-to-edge distance between the first electrode and the second electrode along the propagation length.

60. The ignition system of any one of inventive aspects 52 to 59, wherein the first electrode and the second electrode extend at least from a surface of the isolator to the distal tip, and the propagation length is between the surface of the isolator and the distal tip.

61. The ignition system of inventive aspect 60, wherein the first electrode and the second electrode have portions elongated substantially parallel to one another in first direction between the surface of the isolator and the distal tip.

62. The ignition system of inventive aspect 61, wherein the portions of the first electrode and the second electrode are further elongated substantially parallel to one another in the first direction on a side of the surface of the isolator opposite the distal tip.

63. The ignition system of inventive aspect 61 or 62, wherein a central axis of the first electrode in the first direction and a central axis of the second electrode in the first direction are offset from one another in a plane that is orthogonal to the first direction.

64. The ignition system of any one of inventive aspects 52 to 63, wherein the isolator comprises ceramic, and the propagation length is from a point located proximate a surface of the ceramic to the distal tip.

65. The ignition system of any one of inventive aspects 52 to 64, wherein the circuitry comprises:
an inductance; and
an energy storage device configured to apply the breakdown voltage and the controlled pulse of electrical energy across the first electrode and the second electrode via the inductance.

66. The ignition system of inventive aspect 65, wherein:
the inductance comprises a transformer having a core;
the energy storage device is configured to apply the breakdown voltage and the controlled pulse of electrical energy across the first electrode and the second electrode via the transformer; and
the transformer is configured to maintain saturation of the core between application of the breakdown voltage and application of the controlled pulse of electrical energy.

67. The ignition system of inventive aspect 65 or 66, wherein the circuitry further comprises:
a switch coupled in a path from the first electrode and the second electrode that includes the energy storage device and the inductance; and
a switch controller configured to close the switch to pass the controlled pulse of electrical energy from the energy storage device to the inductance for applying across the first electrode and the second electrode.

68. The ignition system of any one of inventive aspects 52 to 67, wherein the circuitry is configured to apply the breakdown voltage and the controlled pulse of electrical energy only while at least the distal tip of the first electrode is proximate to an environment having a peak pressure below 300 pounds per square inch (PSI).

69. An ignition system, comprising:
an igniter, comprising:
   a first electrode and a second electrode, the first electrode having a distal tip; and
   an isolator spacing apart the first electrode and the second electrode, the first electrode having a length from the isolator to the distal tip; and
circuitry configured to:
   apply, across the first electrode and the second electrode, a breakdown voltage sufficient to induce breakdown between a first point along the first electrode and a second point along the second electrode, resulting in formation of plasma between the first point and the second point; and
   apply, across the first electrode and the second electrode, a controlled pulse of electrical energy sufficient to prevent total recombination of the plasma,
   wherein a ratio of a length of the first electrode, from the first point to the distal tip, to an edge-to-edge distance between the first electrode and the second electrode, along the length of the first electrode from the first point to the distal tip, is at least 1.75:1.

70. The ignition system of inventive aspect 69, wherein the circuitry is further configured to apply, across the first electrode and the second electrode, after applying the controlled pulse of electrical energy, a second pulse of electrical energy sufficient to further propagate the plasma toward the distal tip of the first electrode.

71. The ignition system of inventive aspect 69 or 70, wherein the circuitry comprises an active circuit component configured to apply the controlled pulse of electrical energy across the first electrode and the second electrode.

72. The ignition system of any one of inventive aspects 69 to 71, wherein the ratio is at least 2:1.

73. The ignition system of any one of inventive aspects 69 to 72, wherein the edge-to-edge distance is selected from a group consisting of:
a shortest edge-to-edge distance between the first electrode and the second electrode along the length of the first electrode from the first point to the distal tip;
a longest edge-to-edge distance between the first electrode and the second electrode along the length of the first electrode from the first point to the distal tip; and
an average edge-to-edge distance between the first electrode and the second electrode along the length of the first electrode from the first point to the distal tip.

74. The ignition system of any one of inventive aspects 69 to 72, wherein the edge-to-edge distance is a shortest edge-to-edge distance between the first electrode and the second electrode along the length of the first electrode from the first point to the distal tip.

75. The ignition system of any one of inventive aspects 69 to 72, wherein the edge-to-edge distance is a longest edge-to-edge distance between the first electrode and the second electrode along the length of the first electrode from the first point to the distal tip.

76. The ignition system of any one of inventive aspects 69 to 72, wherein the edge-to-edge distance is an average edge-to-edge distance between the first electrode and the second electrode along the length of the first electrode from the first point to the distal tip.

77. The ignition system of any one of inventive aspects 69 to 76, wherein the first electrode and the second electrode extend at least from a surface of the isolator to the distal tip, and the first point and the second point are between the surface of the isolator and the distal tip.

78. The ignition system of inventive aspect 77, wherein the first electrode and the second electrode have portions elongated substantially parallel to one another in first direction between the surface of the isolator and the distal tip.

79. The ignition system of inventive aspect 78, wherein the portions of the first electrode and the second electrode are further elongated substantially parallel to one another in the first direction on a side of the surface of the isolator opposite the distal tip.

80. The ignition system of inventive aspect 78 or 79, wherein a central axis of the first electrode in the first direction and a central axis of the second electrode in the first direction are offset from one another in a plane that is orthogonal to the first direction.

81. The ignition system of any one of inventive aspects 69 to 80, wherein, prior to breakdown, an impedance between the first point and the second point is a lowest impedance between the first electrode and the second electrode.

82. The ignition system of any one of inventive aspects 69 to 81, wherein the isolator comprises ceramic, and the first point and the second point are located proximate a surface of the ceramic.

83. The ignition system of any one of inventive aspects 69 to 82, wherein the circuitry comprises:
an inductance; and
an energy storage device configured to apply the breakdown voltage and the controlled pulse of electrical energy across the first electrode and the second electrode via the inductance.

84. The ignition system of inventive aspect 83, wherein:
the inductance comprises a transformer having a core;
the energy storage device is configured to apply the breakdown voltage and the controlled pulse of electrical energy across the first electrode and the second electrode via the transformer; and
the transformer is configured to maintain saturation of the core between application of the breakdown voltage and application of the controlled pulse of electrical energy.

85. The ignition system of inventive aspect 83 or 84, wherein the circuitry further comprises:
a switch coupled in a path from the first electrode and the second electrode that includes the energy storage device and the inductance; and
a switch controller configured to close the switch to pass the controlled pulse of electrical energy from the energy storage device to the inductance for applying across the first electrode and the second electrode.

86. The ignition system of any one of inventive aspects 69 to 85, wherein the circuitry is configured to apply the breakdown voltage and the controlled pulse of electrical energy only while at least the distal tip of the first electrode is proximate to an environment having a peak pressure below 300 pounds per square inch (PSI).

87. A plasma generation system, comprising:
a plasma generator, comprising:
   a first electrode and a second electrode; and
   an isolator spacing apart the first electrode and the second electrode; and
circuitry configured to:
   create a low voltage, low impedance path in an initiation region between the first and second electrodes; and
   apply, across the first and second electrodes, at least one subsequent pulse of electrical energy sufficient to propagate the plasma from the initiation region toward a distal tip of the first and second electrodes,
   wherein a ratio of a length of the first and second electrodes, from the initiation region to the distal tip, to an edge-to-edge distance between the first and second electrodes, along the length of the first and second electrodes from the initiation region to the distal tip, is at least 1.75:1.

88. The plasma generation system of inventive aspect 87, wherein the circuitry is configured to create the low voltage, low impedance path by initiating a flow of current between the first and second electrodes at the initiation region.

89. The plasma generation system of inventive aspect 88, wherein the circuitry is configured to initiate the flow of current by applying, across the first and second electrodes, a breakdown voltage sufficient to induce breakdown between the first and second electrodes, resulting in formation of plasma in the initiation region.

1. A plasma generation system, comprising:
a plasma generator, comprising:
a first electrode and a second electrode; and
an isolator spacing apart the first electrode and the second electrode; and
circuitry configured to:
apply, across the first and second electrodes, a breakdown voltage sufficient to induce breakdown between the first and second electrodes, resulting in formation of plasma in an initiation region between the electrodes; and
apply, across the first and second electrodes, at least one subsequent pulse of electrical energy sufficient to propagate the plasma from the initiation region toward a distal tip of the first and second electrodes,
wherein a ratio of a length of the first and second electrodes, from the initiation region to the distal tip, to an edge-to-edge distance between the first and second electrodes, along the length of the first and second electrodes from the initiation region to the distal tip, is at least 1.75:1.

2. The plasma generation system of claim 1, wherein the edge-to-edge distance is selected from a group consisting of:
a shortest edge-to-edge distance between the first and second electrodes along the length of the first and second electrodes from the initiation region to the distal tip;
a longest edge-to-edge distance between the first and second electrodes along the length of the first and second electrodes from the initiation region to the distal tip; and
an average edge-to-edge distance between the first and second electrodes along the length of the first and second electrodes from the initiation region to the distal tip.

3. The plasma generation system of claim 1, wherein:
each of the first and second electrodes extend from a surface of the isolator to the electrode's distal tip, and the initiation region is between the surface of the isolator and the distal tips;
each of the first and second electrodes have a portion extending substantially parallel to the portion of the other electrode in a first direction; and
the first electrode has a central axis extending in the first direction and the edge-to-edge distance is measured in a plane orthogonal to the central axis.

4. The plasma generation system of claim 1, wherein the first and second electrodes have an impedance between them and wherein, prior to breakdown, the impedance is lowest in the initiation region.

5. The plasma generation system of claim 4, wherein the isolator comprises ceramic and the initiation region is located at a surface of the ceramic.

6. The plasma generation system of claim 1, wherein the circuitry comprises:
an inductance through which the breakdown voltage is applied to the first and second electrodes; and
an energy storage device configured to apply the at least one subsequent pulse of electrical energy across the first and second electrodes via the inductance.

7. The plasma generation system of claim 6, wherein:
the inductance comprises a secondary of a transformer having a saturable core and a primary energized by the circuitry to create the breakdown voltage at the secondary;
the energy storage device is configured to apply the at least one subsequent pulse of electrical energy across the first and second electrodes directly via the secondary; and
the transformer is configured to maintain saturation of the saturable core between application of the breakdown voltage and application of the at least one subsequent pulse of electrical energy.

8. The plasma generation system of claim 6, wherein the circuitry further comprises:
a switching element coupled in a path from the first and second electrodes that includes the energy storage device and the inductance; and
a controller configured to close the switching element to pass the at least one subsequent pulse of electrical energy from the energy storage device to the inductance for applying across the first and second electrodes.

9. The plasma generation system of claim 1, wherein the circuitry is configured to apply the breakdown voltage and the at least one subsequent pulse of electrical energy only while the first and second electrodes are in an environment having a peak pressure below 300 pounds per square inch (PSI).

10. A plasma generation system, comprising:
a plasma generator, comprising:
a first electrode and a second electrode; and
an isolator spacing apart the first electrode and the second electrode; and
circuitry configured to:
apply, across the first and second electrodes, a breakdown voltage sufficient to cause breakdown between a first point on the first electrode and a second point on the second electrode, resulting in formation of plasma in an initiation region between the first point and second point; and
apply, across the first and second electrodes, subsequent pulses of electrical energy sufficient to propagate the plasma from the first point to a distal tip of the first electrode,
wherein the first electrode has a propagation length extending in a first direction from the first point to the distal tip of the first electrode;
wherein the first and second electrodes have an edge-to-edge distance between the electrodes measured along the propagation length in one or more planes orthogonal to the first direction; and
wherein the ratio of the propagation length of the first electrode to the edge-to-edge distance is at least 1.75:1.

11. The plasma generation system of claim 10, wherein the ratio is not more than 12:1.

12. The plasma generation system of claim 10, wherein the circuitry is configured to apply the subsequent pulses at a current in excess of 450 Amps.

13. The plasma generation system of claim 10, wherein the circuitry is configured to apply one or more of the subsequent pulses at a current in excess of 600 Amps.

14. The plasma generation system of claim 10, wherein the circuitry is configured to apply one or more of the subsequent pulses with a current rise time rate of at least 20 μsec/100 Amps.

15. The plasma generation system of claim 10, further comprising one or more additional electrodes spaced from the first electrode by the insulator, the additional electrode(s) being electrically connected to the second electrode whereby the circuitry applies the breakdown voltage and subsequent pulses between the first electrode and both the second electrode and additional electrode(s), wherein the additional electrode(s) have an edge-to-edge distance with the first electrode such that the ratio of the propagation length of the first electrode to the edge-to-edge distance of the additional electrode(s) is at least 1.75:1.

16. An ignition system for combusting fuel in a reaction environment, wherein the ignition system comprises the plasma generation system of claim 15 and wherein the plasma generator comprises an igniter of the ignition system.

17. The plasma generation system of claim 10, wherein the circuitry is configured to control one or more of the following parameters of the subsequent pulses: pulse timing, pulse energy, pulse width, pulse amplitude, current rise time, current rise time rate, voltage rise time, and voltage rise time rate.

18. An ignition system, comprising:
an igniter, comprising:
a first electrode and a second electrode, the first electrode having a distal tip; and
an isolator spacing apart the first electrode and the second electrode, the first electrode having an exposed length extending from the isolator to the distal tip; and
circuitry configured to:
apply, across the first electrode and the second electrode, a breakdown voltage sufficient to cause breakdown between the first electrode and the second electrode at a point along the exposed length of the first electrode, resulting in formation of plasma between the first and second electrodes; and
apply, across the first electrode and the second electrode, one or more subsequent pulses of electrical energy sufficient to maintain the plasma during and between application of the pulses,
wherein a ratio of the exposed length of the first electrode to an edge-to-edge distance between the first electrode and the second electrode is at least 1.75:1.

19. The ignition system of claim 18, wherein the second electrode has a distal tip and an exposed length extending from the isolator to the distal tip of the second electrode, wherein:
the exposed length of the first electrode is less than the exposed length of the second electrode;
the exposed length of the first electrode is equal to the exposed length of the second electrode; or
the exposed length of the first electrode is greater than the exposed length of the second electrode.

20. The ignition system of claim 19, wherein, when the exposed length of the first electrode is less than the exposed length of the second electrode, then the ratio is a ratio of the exposed length of the first electrode to the edge-to-edge distance along the exposed length of the first electrode and, when the exposed length of the first electrode is greater than the exposed length of the second electrode, then the ratio is a ratio of the exposed length of the first electrode to the edge-to-edge distance along the exposed length of the second electrode.

21. A plasma generator, comprising:
a housing;
a first electrode and a second electrode each mounted in the housing and extending from the housing to a distal tip; and
an isolator mounted in the housing, the first and second electrodes being spaced apart by the isolator;
wherein the first and second electrodes each include an electrode surface extending from the isolator to the distal tip of the electrode;
wherein the electrode surfaces of each electrode include a firing region extending for a length L along the electrodes;
wherein the firing regions each comprise a portion of the electrode surface that is located nearer to the other electrode's surface than any other portion of the electrode surface;
wherein the electrodes have an edge-to-edge distance D along the length L of the firing region; and
wherein the ratio of the length L to the edge-to-edge distance D along the length is at least 1.75:1.

22. The plasma generator of claim 21, wherein the isolator has an exposed isolator surface located between the first and second electrodes at a proximal end of the electrodes, wherein the first and second electrodes have an impedance between them and wherein, prior to breakdown, the impedance is lowest on the isolator surface.

23. The plasma generator of claim 22, wherein the firing region extends from the isolator surface to the distal tip of each of the electrodes, whereby the length L is the distance from the isolator surface to the distal tip of at least one of the electrodes.

24. The plasma generator of claim 23, wherein the first and second electrodes extend above the isolator surface by different distances such that one of the electrodes is a longer electrode and the other of the electrodes is a shorter electrode, and wherein the length is the distance from the isolator surface to the distal tip of the shorter electrode.

25. The plasma generator of claim 21, further comprising an inductance coupled to the first and second electrodes, the inductance comprising a coil having no more than 100 turns.

26. An ignition system comprising the plasma generator of claim 21 and circuitry configured to:
apply, across the first and second electrodes, a breakdown voltage sufficient to cause breakdown between the first and second electrodes, resulting in formation of plasma in the firing region between the electrodes; and
apply, across the first and second electrodes, at least one subsequent pulse of electrical energy sufficient to propagate the plasma along the firing region toward the distal tips of the first and second electrodes.
